(19) United States
(12) Patent Application Publication
(10) Pub. No.: US 2011/0205669 A1
(43) Pub. Date: Aug. 25, 2011

(54) METHOD FOR MANUFACTURING MAGNETO-RESISTANCE EFFECT ELEMENT, MAGNETIC HEAD ASSEMBLY, AND MAGNETIC RECORDING AND REPRODUCING APPARATUS

(75) Inventors: Shuichi Murakami, Tokyo (JP); Hiromi Yuasa, Kanagawa-ken (JP); Michiko Hara, Kanagawa-ken (JP); Yoshihiko Fuji, Kanagawa-ken (JP); Hideaki Fukuzawa, Kanagawa-ken (JP); Kunliang Zhang, Fremont, CA (US); Min Li, Dublin, CA (US)

(73) Assignees: Kabushiki Kaisha Toshiba, Tokyo (JP); TDK CORPORATION, Tokyo (JP)

(21) Appl. No.: 12/881,879

(22) Filed: Sep. 14, 2010

(30) Foreign Application Priority Data
Feb. 22, 2010 (JP) 2010-036651

(51) Int. Cl. G11B 5/48; B05D 3/06; B05D 1/36

(52) U.S. Cl. 360/246.1; 427/539

(57) ABSTRACT

According to one embodiment, a method for manufacturing a magneto-resistance effect element is disclosed. The element has first and second magnetic layers, and an intermediate layer provided between the first and second magnetic layers. The intermediate layer has an insulating layer and a conductive portion penetrating through the insulating layer. The method can include forming a structure body having the insulating layer and the conductive portion, performing a first treatment including irradiating the structure body with at least one of ion including at least one selected from the group consisting of argon, xenon, helium, neon and krypton and a plasma including at least one selected from the group, and performing a second treatment including at least one of exposure to gas containing oxygen or nitrogen, irradiation of ion beam containing oxygen or nitrogen, irradiation of plasma containing oxygen or nitrogen, to the structure body submitted to the first treatment.

### CROSS-REFERENCE TO RELATED APPLICATIONS

This application is based upon and claims the benefit of priority from the prior Japanese Patent Application No. 2010-036651, filed on Feb. 22, 2010; the entire contents of which are incorporated herein by reference.

### FIELD

Embodiments described herein relate generally to a method for manufacturing a magneto-resistance effect element, a magnetic head assembly, and a magnetic recording and reproducing apparatus.

### BACKGROUND

Applications of a spin valve film (SV film) utilizing the giant magneto-resistive effect (GMR) to magnetic devices such as magnetic head and MRAM (magnetic random access memory) are expected to expand.

Various configurations of a magneto-resistance effect element using the spin valve film are presented. Among them, a CPP (current perpendicular to plane)-GMR element in which a sense current is passed in a direction nearly perpendicular to the surface of the spin valve film is drawing attention as a technology compatible with a high recording density head.

JP-A 2006-54257 (Kokai) presents a method for manufacturing a magneto-resistance effect element that includes: a magnetization fixed layer; a magnetization free layer; an insulating layer provided therebetween; and a spacer including a current path penetrating through the insulating layer, in order to achieve a high MR ratio. In the method, a first metallic layer that forms a current path and a second metallic layer that is converted into an insulating layer are formed; pretreatment of irradiation with an ion beam or RF plasma of a rare gas is performed; and oxidizing gas or nitriding gas is supplied to convert the second metallic layer into the insulating layer and form the current path.

Furthermore, JP-A 2008-16739 (Kokai) discloses a technology in which an insulating layer obtained by changing a second metallic layer is irradiated with ions or plasma to increase the adhesion between layers to improve reliability.

There is room for improvement in further increase in the MR ratio.

### BRIEF DESCRIPTION OF THE DRAWINGS

FIG. 1 is a flow chart illustrating a method for manufacturing a magneto-resistance effect element;

FIGS. 2A to 2C are sequential schematic cross-sectional views illustrating the method for manufacturing a magneto-resistance effect element;

FIG. 3 is a schematic perspective view illustrating a magneto-resistance effect element to which the method for manufacturing a magneto-resistance effect element is applied;

FIG. 4 is a schematic view illustrating the operation of the magneto-resistance effect element;

FIG. 5 is a schematic cross-sectional view illustrating the operation of the magneto-resistance effect element;

FIGS. 6A and 6B are flow charts illustrating another method for manufacturing a magneto-resistance effect element;

FIG. 7 is a flow chart illustrating part of the method for manufacturing a magneto-resistance effect element;

FIGS. 8A to 8C are sequential schematic cross-sectional views illustrating part of the method for manufacturing a magneto-resistance effect element;

FIG. 9 is a graph illustrating characteristics of the magneto-resistance effect elements according to a practical example and comparative examples;

FIG. 10 is a graph illustrating characteristics of the magneto-resistance effect elements according to a practical example and comparative examples;

FIG. 11 is a schematic view illustrating a manufacturing apparatus that may be used for the method for manufacturing a magneto-resistance effect element according to the embodiment;

FIG. 12 is a flow chart illustrating the method for manufacturing a magneto-resistance effect element;

FIG. 13 is a schematic perspective view illustrating a magneto-resistance effect element to which a method for manufacturing a magneto-resistance effect element is applied;

FIG. 14 is a schematic perspective view illustrating a magneto-resistance effect element to which a method for manufacturing a magneto-resistance effect element is applied;

FIG. 15 and FIG. 16 are schematic cross-sectional views illustrating a magneto-resistance effect element;

FIG. 17 is a schematic perspective view illustrating part of a magnetic recording and reproducing apparatus;

FIG. 18 is a schematic perspective view illustrating part of the magnetic recording and reproducing apparatus;

FIG. 19 is a schematic perspective view illustrating a magnetic recording and reproducing apparatus;

FIGS. 20A and 20B are schematic perspective views illustrating part of the magnetic recording and reproducing apparatus;

FIG. 21 is a schematic diagram illustrating a magnetic recording and reproducing apparatus;

FIG. 22 is a schematic diagram illustrating a magnetic recording and reproducing apparatus;

FIG. 23 is a schematic cross-sectional view illustrating a relevant part of the magnetic recording and reproducing apparatus; and

FIG. 24 is a cross-sectional view taken along line A-A′ of FIG. 23.

### DETAILED DESCRIPTION

In general, according to one embodiment, a method for manufacturing a magneto-resistance effect element is disclosed. The element has a first magnetic layer including a ferromagnetic material, a second magnetic layer including a ferromagnetic material and an intermediate layer provided between the first magnetic layer and the second magnetic layer. The intermediate layer has an insulating layer and a conductive portion penetrating through the insulating layer. The method can include forming a structure body having the insulating layer and the conductive portion penetrating through the insulating layer. The method can include performing a first treatment including irradiating the structure body with at least one of an ion including at least one selected from the group consisting of argon, xenon, helium, neon and krypton and a plasma including at least one selected from the group consisting of argon, xenon, helium, neon and krypton. In addition, the method can include performing a second treatment including at least one of exposure to a gas containing oxygen, irradiation of ion beam containing oxygen, irradiation of plasma containing oxygen, exposure to a gas containing nitrogen, irradiation of ion beam containing nitrogen, and irradiation of plasma containing nitrogen, to the structure body submitted to the first treatment.

According to one embodiment, a magnetic head assembly, includes a magneto-resistance effect element; a suspension mounting the magneto-resistance effect element in one edge of the suspension; and an actuator arm connected to another edge of the suspension. The magneto-resistance effect element includes: a first magnetic layer including the ferromagnetic material; a second magnetic layer including the ferromagnetic material; and an intermediate layer provided between the first magnetic layer and the second magnetic layer, the intermediate layer having the insulating layer and the conductive portion penetrating through the insulating layer. The magneto-resistance effect element is manufactured by a method including forming a structure body having the insulating layer and the conductive portion penetrating through the insulating layer. The method includes performing a first treatment including irradiating the structure body with at least one of an ion including at least one selected from the group consisting of argon, xenon, helium, neon and krypton and a plasma including at least one selected from the group consisting of argon, xenon, helium, neon and krypton. The method includes performing a second treatment including at least one of exposure to a gas containing oxygen, irradiation of ion beam containing oxygen, irradiation of plasma containing oxygen, exposure to a gas containing nitrogen, irradiation of ion beam containing nitrogen, and irradiation of plasma containing nitrogen, to the structure body submitted to the first treatment.

According to one embodiment, a magnetic recording and reproducing apparatus includes a magnetic head assembly and a magnetic recording medium. The magnetic head assembly includes; a magneto-resistance effect element; a suspension mounting the magneto-resistance effect element in one edge of the suspension; and an actuator arm connected to another edge of the suspension. Information is recorded in the magnetic recording medium by using the magneto-resistance effect element mounted on the magnetic head assembly. The magneto-resistance effect element includes: a first magnetic layer including the ferromagnetic material; a second magnetic layer including the ferromagnetic material; and an intermediate layer provided between the first magnetic layer and the second magnetic layer, the intermediate layer having the insulating layer and the conductive portion penetrating through the insulating layer. The magneto-resistance effect element is manufactured by a method including: forming a structure body having the insulating layer and the conductive portion penetrating through the insulating layer. The method includes performing a first treatment including irradiating the structure body with at least one of an ion including at least one selected from the group consisting of argon, xenon, helium, neon and krypton and a plasma including at least one selected from the group consisting of argon, xenon, helium, neon and krypton. The method includes performing a second treatment including at least one of exposure to a gas containing oxygen, irradiation of ion beam containing oxygen, irradiation of plasma containing oxygen, exposure to a gas containing nitrogen, irradiation of ion beam containing nitrogen, and irradiation of plasma containing nitrogen, to the structure body submitted to the first treatment.

Embodiments will now be described with reference to the drawings.

The drawings are schematic or conceptual; and the relationships between the thickness and width of portions, the proportional coefficients of sizes among portions, etc., are not necessarily the same as the actual values thereof. Further, the dimensions and proportional coefficients may be illustrated differently among drawings, even for identical portions.

In the specification of the application and the drawings, components similar to those described in regard to a drawing thereinabove are marked with the same reference numerals, and a detailed description is omitted as appropriate.

### First Embodiment

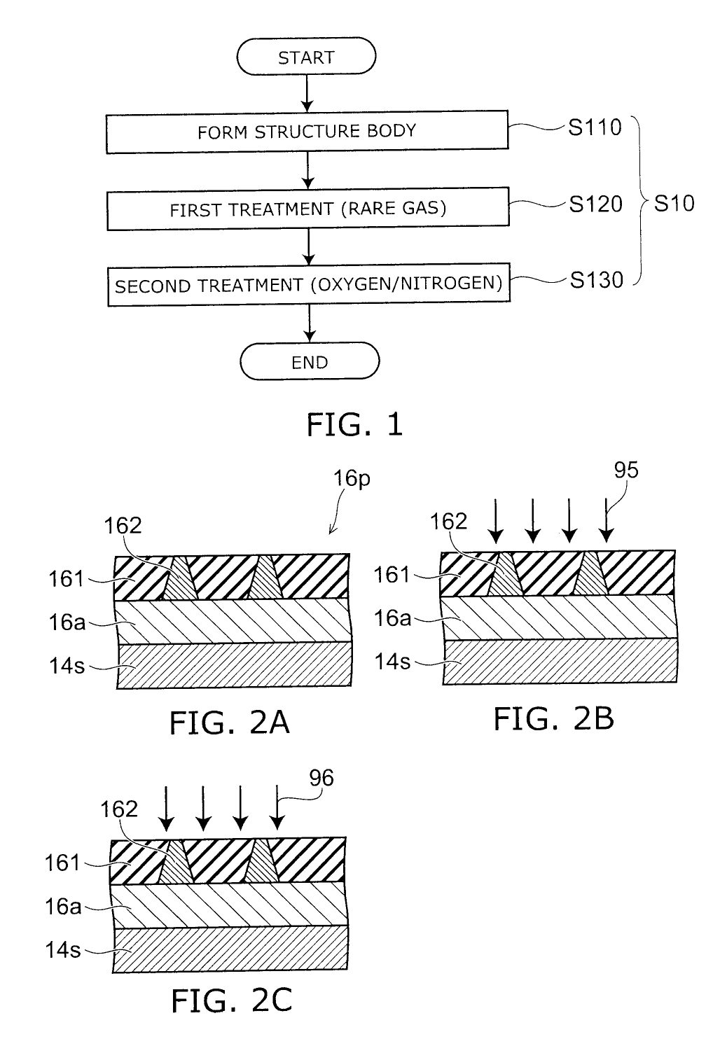

FIG. 1 is a flow chart illustrating a method for manufacturing a magneto-resistance effect element according to a first embodiment.

FIGS. 2A to 2C are sequential schematic cross-sectional views illustrating the method for manufacturing a magneto-resistance effect element according to the first embodiment.

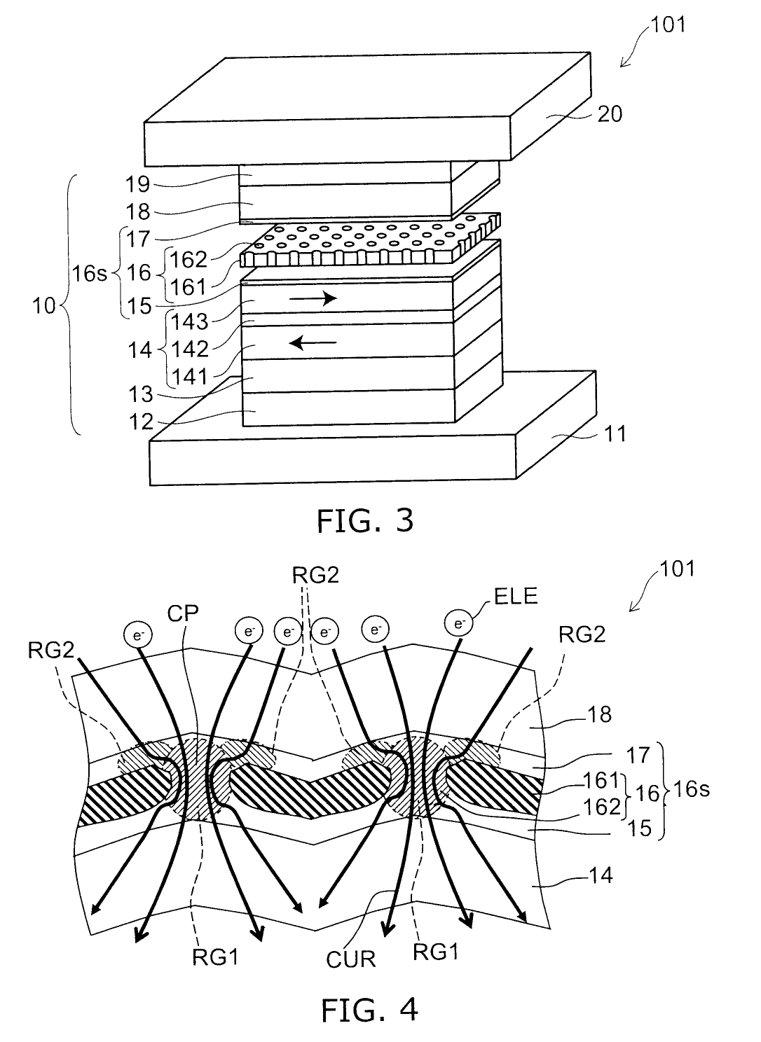

FIG. 3 is a schematic perspective view illustrating the configuration of a magneto-resistance effect element to which the method for manufacturing a magneto-resistance effect element according to the first embodiment is applied.

First, a magneto-resistance effect element 101 to which the method for manufacturing a magneto-resistance effect element according to the first embodiment is applied will now be described with reference to FIG. 3. The following is an example of the configuration of the magneto-resistance effect element, and the magneto-resistance effect element to which the manufacturing method according to this embodiment is applied may be altered variously.

As illustrated in FIG. 3, the magneto-resistance effect element 101 includes: a first magnetic layer (in this specific example, a pinned layer 14) containing a ferromagnetic; a second magnetic layer (in this specific example, a free layer 18) containing a ferromagnetic; and an intermediate layer 16 provided between the first magnetic layer and the second magnetic layer. The intermediate layer 16 includes an insulating layer 161 and a conductive portion 162 penetrating through the insulating layer 161.

In this specific example, the magnetization direction of one of the first magnetic layer and the second magnetic layer is substantially fixed, and the magnetization direction of the other of the first magnetic layer and the second magnetic layer changes in accordance with an external magnetic field applied to the other of the first magnetic layer and the second magnetic layer. Herein, the first magnetic layer is the pinned layer 14 of which the magnetization direction is substantially fixed, and the second magnetic layer is the free layer 18 of which the magnetization direction changes in accordance with an applied external magnetic field.

Specifically, the magneto-resistance effect element 101 includes: a bottom electrode 11; a top electrode 20; and a magneto-resistance effect film 10 provided between the bottom electrode 11 and the top electrode 20. The magneto-resistance effect element 101 is provided on a not-illustrated substrate, for example. The magneto-resistance effect element 101 is a magneto-resistance effect element that detects magnetism by passing a sense current in the direction perpendicular to the surface of the magneto-resistance effect film 10.

In the magneto-resistance effect film 10, for example, an underlayer 12, a pining layer (antiferromagnetic layer) 13, the pinned layer 14, a bottom metallic layer 15, the intermediate layer 16 (the insulating layer 161 and the conductive portion 162), a top metallic layer 17, the free layer 18, and a cap layer (protective layer) 19 are stacked in this order. That is, the magneto-resistance effect element 101 of this specific example is a bottom-pinned magneto-resistance effect element in which the pinned layer 14 is located lower than the free layer 18. In FIG. 3, for easier viewing, the intermediate layer 16 is illustrated to be separated from the layers thereon and therebelow (the bottom metallic layer 15 and the top metallic layer 17).

The pinned layer 14 includes a bottom pinned layer 141, an antiparallel magnetic coupling layer (magnetic coupling layer) 142, and a top pinned layer 143.

The magneto-resistance effect element 101 further includes: a first nonmagnetic layer (in this specific example, the bottom metallic layer 15) provided between the first magnetic layer (in this specific example, the pinned layer 14) and the intermediate layer 16; and a second nonmagnetic layer (in this specific example, the top metallic layer 17) provided between the second magnetic layer (in this specific example, the free layer 18) and the intermediate layer 16.

Here, the first magnetic layer and the second magnetic layer may be replaced with each other. Therefore, the first nonmagnetic layer and the second nonmagnetic layer may be replaced with each other in conjunction with the first magnetic layer and the second magnetic layer.

The magneto-resistance effect element 101 includes a spin valve film. The spin valve film has a configuration in which a nonmagnetic spacer layer 16s is placed between two ferromagnetic layers (in this specific example, the pinned layer 14 and the free layer 18). In this specific example, the spacer layer 16s includes the bottom metallic layer 15, the intermediate layer 16, and the top metallic layer 17. The spin valve film includes the pinned layer 14, the spacer layer 16s (the bottom metallic layer 15, the intermediate layer 16, and the top metallic layer 17), and the free layer 18. The spin valve film may be referred to as a spin dependent scattering unit.

In the spin valve film, the magnetization of one (e.g. the pinned layer 14) of the two ferromagnetic layers is fixed by an antiferromagnetic layer or the like, and the magnetization of the other (e.g. the free layer 18) is rotatable in accordance with an external magnetic field. In the spin valve film, the relative angle of the magnetization directions of the pinned layer and the free layer changes, and thereby a very large magneto-resistance change is obtained. As described later, both of the two ferromagnetic layers may be rotatable in accordance with an external magnetic field.

In the magneto-resistance effect element 101, the intermediate layer 16 including a current path that conducts a current along the thickness direction is used as the spacer layer 16s. That is, in the intermediate layer 16, the conductive portion 162 penetrates through the insulating layer 161, and the conductive portion 162 forms a current path that conducts a current along the thickness direction of the intermediate layer 16. This configuration can increase both the element resistance and the MR ratio of the magneto-resistance effect element 101 due to the current-confined-path (CCP) effect. An element with this configuration may be referred to as a CCP (current-confined-path)-CPP (current perpendicular to plane) element.

The intermediate layer 16 may be referred to as an NOL (nano-oxide layer). However, the term “NOL” is for the sake of convenience. It is sufficient that the insulating layer 161 in the intermediate layer 16 is an insulating layer including a current path (the conductive portion 162) that conducts a current along the thickness direction of the insulating layer 161, and not only oxide but also an optional insulating material such as nitride and oxynitride may be used for the insulating layer 161.

Various magnetic materials may be used for the pinned layer 14 and the free layer 18. The pinned layer 14 and the free layer 18 are described later.

Metal oxide, metal nitride, metal oxynitride, and the like, for example, are mainly used for the insulating layer 161 in the intermediate layer 16. For example, Al₂O₃ is used for the insulating layer 161.

The conductive portion 162 functions as a conductor that conducts a current in the direction perpendicular to the surface of the insulating layer 161. That is, the insulating layer 16 has a current-confined-path structure (CCP structure) by means of the insulating layer 161 and the conductive portion 162, and the MR ratio is increased by the current-confined-path effect. A metal is mainly used for the conductive portion 162. For example, a metal such as Cu is used for the conductive portion 162.

As illustrated in FIG. 1 and FIGS. 2A to 2C, the method for manufacturing a magneto-resistance effect element according to this embodiment includes an intermediate layer formation process (step S10) that forms the intermediate layer 16. The intermediate layer formation process includes a structure body formation process (step S110), a first treatment process (step S120), and a second treatment process (step S130).

As illustrated in FIG. 2A, the structure body formation process is a process that forms a structure body 16p including the insulating layer 161 and the conductive portion 162 penetrating through the insulating layer 161.

As illustrated in FIG. 2B, the first treatment process is a process that irradiates the structure body 16p with at least one of ions and plasma containing at least one selected from a group consisting of argon, xenon, helium, neon, and krypton. For example, the structure body 16p is irradiated with an Ar ion beam 95.

As illustrated in FIG. 2C, the second treatment process is a process that performs at least one of: exposure to gas containing oxygen; irradiation with an ion beam containing oxygen; irradiation with plasma containing oxygen; exposure to gas containing nitrogen; irradiation with an ion beam containing nitrogen; and irradiation with plasma containing nitrogen, on the structure body 16p having undergone the first treatment process.

The irradiation with an ion beam containing oxygen mentioned above includes irradiation with an ion beam containing: at least one selected from a group consisting of argon, xenon, helium, neon, and krypton; and oxygen. The irradiation with plasma containing oxygen mentioned above includes irradiation with plasma containing: at least one selected from a group consisting of argon, xenon, helium, neon, and krypton; and oxygen. The irradiation with an ion beam containing nitrogen mentioned above includes irradiation with an ion beam containing: at least one selected from a group consisting of argon, xenon, helium, neon, and krypton; and nitrogen. The irradiation with plasma containing nitrogen mentioned above includes irradiation with plasma containing: at least one selected from a group consisting of argon, xenon, helium, neon, and krypton; and nitrogen.

In the second treatment process, for example, the structure body 16p having undergone the first treatment is irradiated with an oxygen beam 96.

That is, the structure body 16p formed by the structure body formation process has a configuration including the insulating layer 161 and the conductive portion 162 penetrating through the insulating layer 161; however, the structure body 16p is in a state before becoming the intermediate layer 16, and changes into the intermediate layer 16 by performing the first treatment process and the second treatment process on the structure body 16p, which improves characteristics of the intermediate layer 16 and consequently increases the MR ratio of the magneto-resistance effect element 101.

Hereinafter, the first treatment process is referred to as “AIT” (after ion treatment). Furthermore, in the case where the second treatment process is one of exposure to gas containing oxygen, irradiation with an ion beam containing oxygen, and irradiation with plasma containing oxygen, such treatment is referred to as, in particular, “AO” (additional oxidation). Hereinbelow, the case is described where the second treatment process is the AO.

A mechanism will now be described in which performing the AIT and the AO in combination on the structure body 16p increases the MR ratio. Hereinbelow, to simplify description, the case where the insulating layer 161 is oxide is described as an example.

FIG. 4 is a schematic view illustrating the operation of the magneto-resistance effect element according to the first embodiment.

That is, the drawing is a schematic cross-sectional view illustrating the operation of the magneto-resistance effect element 101, and illustrates schematically an enlarged view of the portion of the spin valve film.

As illustrated in FIG. 4, when a current CUR is passed between the pinned layer 14 and the free layer 18, the current CUR flows through the conductive portion 162 in the intermediate layer 16. That is, a current path CP is formed in the conductive portion 162. The current CUR concentrates in the current path CP of the conductive portion 162.

That is, the current CUR is confined and conduction electrons ELE concentrate near the current path CP of the conductive portion 162. The conductive portion 162 forms a region RG1 in which the current density increases, and in the region RG1, the increased current density generates the Joule heat to raise the temperature locally.

On the other hand, a portion of the insulating layer 161 near the current path CP forms a region RG2 in which there is a high possibility that the conduction electrons ELE collide. The conduction electrons ELE collide with the insulating layer 161 in the region RG2 with a certain probability to cause damage to the insulating layer 161. Accordingly, in the case where the insulating layer 161 is an insulator containing a light element such as oxygen, a defect or a partial breakage easily occurs in the insulating layer 161 in the region RG2 due to the kinetic energy of heat or collision by the conduction electron ELE.

Furthermore, the crystallinity of the insulating layer 161 is different from the crystallinity of the metal of the conductive portion 162. Accordingly, a lattice mismatch and/or a dangling bond exist at the interface between the insulating layer 161 and the conductive portion 162, and this interface is probably in an unstable state in which atom diffusion, a break, and/or the like occur very easily.

It is probable that the MR ratio greatly depends on characteristics of: the interior of the conductive portion 162 that forms the current path CP; the portion of the insulating layer 161 near the current path CP (the conductive portion 162); and the interface between the insulating layer 161 and the conductive portion 162.

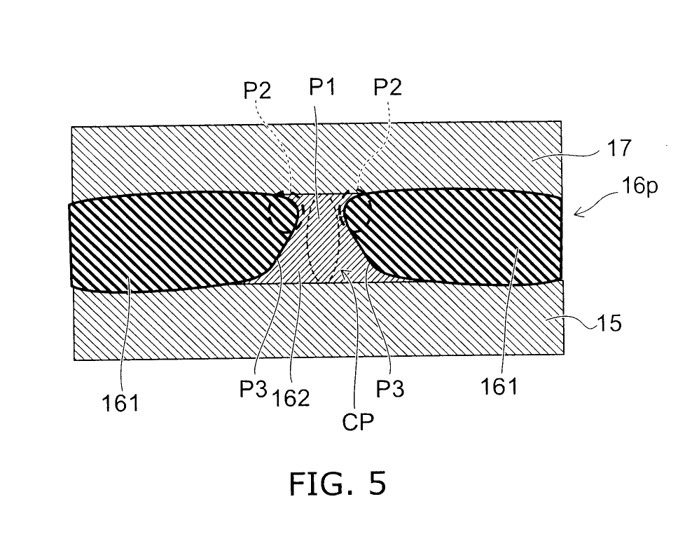

FIG. 5 is a schematic cross-sectional view illustrating the operation of the magneto-resistance effect element according to the first embodiment.

That is, the drawing illustrates a portion in which the conduction electron ELE probably affects the MR ratio when it passes through the current path CP that is a current-confined portion.

As illustrated in FIG. 5, portions affecting the MR ratio are probably: the interior P1 of the current path; a portion P2 of the insulating layer 161 near the current path CP (the conductive portion 162); and the interface P3 between the insulating layer 161 and the conductive portion 162. The states of the three portions affect the MR ratio.

In the manufacturing method according to this embodiment, the AIT is performed on the structure body 16p. The AIT changes the state of the interior P1 of the current path. Specifically, the AIT removes impurities contained in the conductive portion 162 that is the interior P1 of the current path.

For example, at the time of heat treatment performed when the structure body 16p is formed or after the structure body 16p is formed, oxygen remains in the conductive portion 162 that forms the current path CP. The oxygen constitutes impurities contained in the conductive portion 162 that is the interior P1 of the current path. In the manufacturing method according to this embodiment, treatment with ion or plasma of a rare gas, which is the AIT, is performed on the structure body 16p like this. Thereby, the ion or plasma of the rare gas is caused to collide with the remaining oxygen, and the energy of this collision (bombardment effect) is used to move the oxygen remaining in the conductive portion 162 toward the insulating layer 161. This can promote the separation of the conductive portion 162 and the insulating layer 161.

That is, impurities such as oxygen contained in the interior P1 of the current path are removed to increase the purity of the interior P1 of the current path, and thereby the MR ratio increases.

On the other hand, in the case where treatment with ion or plasma of a rare gas (AIT) is performed on the structure body 16p, there is a possibility that, for example, the ion or plasma of the rare gas collides with the insulating layer 161, and thereby oxygen bonded in the insulating layer 161 is flipped off to generate a defect or a partial breakage in the insulating layer 161.

The thinned insulating layer or the defect or partial breakage of oxygen etc. in the case where such AIT is performed degrades characteristics of the portion P2 of the insulating layer 161 near the current path CP, and the interface P3 between the insulating layer 161 and the conductive portion 162. Consequently, the MR ratio is decreased.

That is, by only the AIT, the MR ratio may not be sufficiently increased due to a bad effect that may be caused by performing the AIT.

At this time, in the manufacturing method according to this embodiment, the AIT and the AO are performed in combination, and this eliminates the bad effect that may be caused by the AIT and increases the MR ratio more than when only the AIT is performed.

That is, by further performing the AO on the structure body 16p having undergone the AIT, the oxygen loss state in the insulating layer 161 can be repaired and oxygen can be contained more densely in the insulating layer 161. Thus, the intermediate layer 16 having a higher MR ratio can be obtained.

Performing the AO after the AIT suppresses bad effects due to the breakdown or the oxygen loss of the insulating layer 161, which may occur simultaneously with the promotion of the separation of the insulating layer 161 and the conductive portion 162 in performing the AIT, and can provide a larger MR ratio than in the case of only the AIT.

Thus, it is found out that the MR ratio increases by performing the first treatment (AIT) and the second treatment (e.g. AO) in combination on the structure body 16p after the formation of the structure body 16p. The embodiment is developed based on this new knowledge.

The treatment of ion beam irradiation or plasma irradiation described later, for example, may be performed in order to form the structure body 16p. The treatment conditions at this time are set to such conditions as do not cause a decrease in MR ratio due to the effects of the transformation (e.g. oxidation) of a layer (in this specific example, the pinned layer 14) below the structure body 16p.

For example, in the formation of the structure body 16p, a condition is desired that the concentration of oxygen in the insulating layer 161 be high, so that the insulation properties of the insulating layer 161 in the structure body 16p may be high. However, since the process of the structure body 16p formation is performed while taking into account bad effects on other layers (for example, a decrease in MR ratio due to the oxidation of the pinned layer 14), there may be cases where as a result a condition is used that cannot sufficiently increase the concentration of oxygen in the insulating layer 161.

In contrast, the manufacturing method according to this embodiment performs ion beam irradiation or plasma irradiation (e.g. AIT) on the structure body 16p after forming the structure body 16p, and thereby promotes the separation of the conductive portion 162 and the insulating layer 161 and increases the concentration of oxygen in the insulating layer 161. Furthermore, performing the AO suppresses a decrease in the insulation properties of the structure body 16p which may be caused by the AIT. Consequently, an unprecedented high MR ratio is achieved.

That is, the reason why the MR ratio increases in the manufacturing method according to this embodiment is probably that: performing the first treatment (AIT) on the structure body 16p promotes the separation of the conductive portion 162 and the insulating layer 161 in the structure body 16p more; and bad effects caused in the first treatment (for example, a decrease in insulation properties due to the deterioration of the insulating layer 161) is suppressed.

Thus, the manufacturing method according to this embodiment can manufacture a magneto-resistance effect element with an increased MR ratio.

Along with further expansion in uses of the magnetic memory device and further increase in memory density in the future, it is required to reduce the magnetic signal from a magnetic recording medium and achieve a higher MR ratio than at present. However, the manufacturing method according to this embodiment enables to provide a magneto-resistance effect element that meets these requirements. In particular, since the CCP-CPP element has a lower resistance than conventional TMR elements, this embodiment can be applied to a high-end magnetic memory device for use in server enterprise requiring higher transfer rates, and can achieve a high MR ratio required particularly in such a high-end use.

As described later, oxidation treatment may be performed also in the formation of the structure body 16p. In this case, the AO performed in combination with the AIT after the AIT is a treatment with a smaller oxidation power than the oxidation treatment performed in the formation of the structure body 16p.

That is, performing AO with a strong oxidation power may undesirably regenerate oxygen impurities in the current path CP which have separated the insulating layer 161 and the conductive portion 162 in the process of the structure body 16p formation performed before the AIT. Therefore, the AO after the AIT is set to a treatment with a smaller oxidation power than the oxidation treatment performed in the formation of the structure body 16p.

For example, as a treatment condition of the A0, a smaller accelerating voltage than the energy of the ion beam in the oxidation treatment used in forming the structure body 16p is used. Furthermore, in the AO, a natural oxygen flow that introduces O₂ gas not to be ionized into a chamber and the like are used.

Furthermore, the treatment time of the AO is preferably short in order to suppress excessive impurity generation and oxidation of a magnetic layer such as the pinned layer 14. That is, if surplus oxygen is introduced into the structure body 16p after the AIT, conversely the MR ratio decreases.

For example, in the AO, although an RF power for ionization is supplied at the ion source, a condition is used of exposing to oxygen without using an applied voltage for acceleration. Furthermore, in the AO, the incident angle of the ion beam to the surface of the structure body 16p (here, the incident angle is assumed to be zero degrees in the case of entering parallel to the surface to be treated of an object of treatment, and to be 90 degrees in the case of entering perpendicularly to the surface to be treated) is set to a shallow angle such as an angle close to zero degrees (for example, larger than zero degrees and not more than 15 degrees). Thereby, the oxidation power of the AO can be reduced. The time of ion beam irradiation is preferably not less than 5 seconds and not more than about 60 seconds. Thereby, the oxidation power of the AO can be reduced.

Furthermore, also using a natural oxygen flow as the AO is effective in suppressing excessive oxidation of the pinned layer 14. The treatment time in the case of using a natural oxygen flow is preferably not less than 10 seconds and not more than about 600 seconds, for example. Although even not less than 600 seconds may promise the effects of the AO, not more than 600 seconds is more preferable from the viewpoint of productivity.

In the above, the case is described where the second treatment process is the AO of exposure to gas containing oxygen, irradiation with an ion beam containing oxygen, or irradiation with plasma containing oxygen. However, the second treatment process may be a process that performs at least one of exposure to gas containing oxygen, irradiation with an ion beam containing oxygen, irradiation with plasma containing oxygen, exposure to gas containing nitrogen, irradiation with an ion beam containing nitrogen, and irradiation with plasma containing nitrogen. In the case where nitrogen or oxygen nitrogen mixed gas is used in the second treatment process, effects similar to the above are obtained.

In the case where, for example, the structure body 16p is irradiated with an Ar ion beam or RF plasma of Ar as the AIT, Ar is implanted into the structure body 16p. Accordingly, there is a high possibility that the structure body 16p (the intermediate layer 16) after the AIT contains more Ar than other layers (e.g. various layers illustrated in FIG. 1). For example, the intermediate layer 16 having undergone the AIT using Ar may contain twice or more Ar as compared to other layers. The difference in Ar content between the intermediate layer 16 and other layers can be found by, for example, a composition analysis in combination with a cross-section transmission electron microscope photograph, a depth profile that analyzes a film composition with a SIMS (secondary ion mass spectrum) while performing milling through the surface of the film, or an analysis with a three-dimensional atom probe microscope and the like.

Also in the case where ions or plasma of gas of another element is used in place of those of Ar in the AIT, there is a high possibility that a difference in the contents of elements used is caused between the intermediate layer 16 and other layers, and the difference can be found by an analysis method similar to the above.

The AIT uses ions and plasma containing at least one selected from a group consisting of argon (Ar), xenon (Xe), helium (He), neon (Ne), and krypton (Kr). Ar is preferably used from the viewpoint of manufacturing costs. When Xe or the like having a larger mass is used in place of Ar as necessary, a distinctive effect may be obtained.

In the AIT, ion beam irradiation, for example, of a rare gas (the group mentioned above) is performed.

In the ion beam irradiation, the object of treatment (the structure body 16p, or the structure body 16p and the top metallic layer 17) is irradiated with an ion beam by using an ion gun and the like.

In the ion beam irradiation, gas is ionized and accelerated by a voltage (accelerating voltage) in the ion gun, and thereby the ion beam is emitted from the ion gun. ICP (inductive charge coupled) plasma and the like are used for this ionization. In this case, the plasma amount is controlled through an RF power and the like, and the amount of the ion delivered to the object of treatment is controlled through the amount of a beam current. The energy of the ion beam irradiation is controlled through the value of the accelerating voltage.

In regard to the conditions of the ion beam irradiation in the AIT, it is preferable, for example, to set the accelerating voltage to +30 V (volts) to +150 V, the beam current Ib to 20 mA (milliamperes) to 200 mA, and the RF power to 10 W (watts) to 300 W. The RF power is an electric power that excites plasma at the ion source in order to keep the beam current Ib constant. These conditions are significantly weak as compared to the conditions in the case where, for example, ion beam etching is performed.

In the ion beam irradiation mentioned above, the etching amount is a very minute amount of, for example, 0.5 nm or less, and is greatly different from the etching amount of etching for forming the shape of the element. Since the etching amount is small in the ion beam irradiation in the AIT, the film thickness (0.5 nm or less) of the structure body 16, which has very slightly decreased due to the ion beam irradiation, can be appropriately corrected. For example, the film thickness can be corrected by film-forming the structure body 16p to make it thick in view of the etching amount, in the formation of the structure body 16p. Furthermore, for example, the film thickness can be compensated by the film-formation performed after the AIT.

If the object of treatment is excessively etched by an ion beam of stronger conditions than the above, a bad effect may be caused on characteristics. Excessive etching in the AIT may cause a loss of the structure body 16.

Assuming that the incident angle in the ion beam irradiation is zero degrees in the case where the ion beam enters parallel to the surface to be treated of the object of treatment, and is 90 degrees in the case where the ion beam enters perpendicularly to the surface to be treated, the incident angle in the ion beam irradiation in the AIT is appropriately changed within a range of 0 degrees to 90 degrees.

The treatment time of the ion beam irradiation in the AIT is preferably about 15 seconds to 300 seconds, more preferably 30 seconds or more from the viewpoint of controllability and the like. An excessively long treatment time may reduce the productivity of the magneto-resistance effect element. From these points of view, the treatment time of the ion beam irradiation is still more preferably about 30 seconds to 180 seconds.

In the AIT, also plasma treatment using a rare gas (the group mentioned above) may be performed. Here, performing plasma treatment is referred to as “plasma irradiation.”

In the plasma irradiation, the object of treatment is irradiated with plasma by using a plasma gun and the like. For example, a rare gas is changed into plasma by an RF power, and the plasma is delivered to the surface to be treated of the object of treatment. The current and the energy in the plasma irradiation are controlled through the value of the RF power. That is, the intensity of the plasma irradiation is determined by the value of the RF power. Here, in the plasma irradiation, the accelerating voltage and the beam current are determined by the RF power, and it is difficult to control the current and the energy independently as in the case of the ion beam irradiation.

The energy, time, and the like of the plasma irradiation may be set to values equal to those in the case of the ion beam irradiation. For example, it is preferable to set the accelerating voltage to +30 V to +150 V, the beam current Ib to 20 mA to 200 mA, and the RF power (the RF power for exciting plasma at the ion source in order to keep the beam current constant) to 10 W to 300 W. The RF power is more preferably 10 W to 100 W in order not to cause etching substantially in the plasma irradiation. It is still more preferable to use 10 W to 50 W as the RF power in order to increase controllability.

The treatment time of the plasma irradiation is preferably about 15 seconds to 300 seconds, more preferably 30 seconds or more from the viewpoint of controllability and the like. An excessively long treatment time may reduce the productivity of the magneto-resistance effect element. From these points of view, the treatment time of plasma irradiation is still more preferably about 30 seconds to 180 seconds.

Using the plasma irradiation facilitates the maintenance of the device and can therefore enhance productivity. On the other hand, using the ion beam irradiation allows to control independently the accelerating voltage, the RF power, and the current, and therefore provides high processing controllability. An appropriate method can be adopted in view of these characteristics.

On the other hand, the second treatment uses at least one of exposure to gas containing oxygen, irradiation with an ion beam containing oxygen, irradiation with plasma containing oxygen, exposure to gas containing nitrogen, irradiation with an ion beam containing nitrogen, and irradiation with plasma containing nitrogen. Among them, in regard to the irradiation with an ion beam containing oxygen, the irradiation with plasma containing oxygen, the irradiation with an ion beam containing nitrogen, and the irradiation with plasma containing nitrogen, the rare gas in the irradiation with an ion beam of a rare gas and the irradiation with plasma of a rare gas in the AIT mentioned above may be replaced with oxygen or nitrogen, and a description is therefore omitted.

Furthermore, in the case where treatment with an ion beam containing oxygen, which is a kind of AO, is used as the second treatment, it is preferable in many cases to increase the flow rate of oxygen to shorten the treatment time in order to suppress etching. For example, the flow rate of oxygen is preferably not less than 5 sccm and not more than 10 sccm, and the treatment time is preferably about not less than 5 seconds and not more than 60 seconds. Thereby, etching by the second treatment can be suppressed.

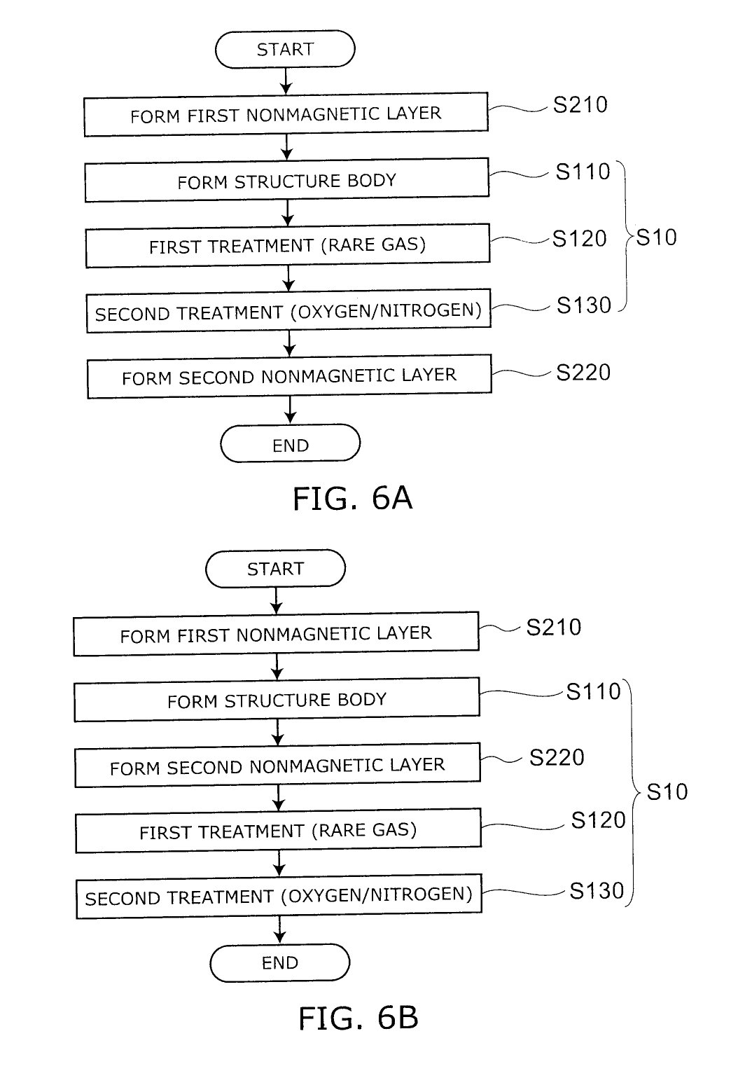

FIGS. 6A and 6B are flow charts illustrating another method for manufacturing a magneto-resistance effect element according to the first embodiment.

As illustrated in FIG. 6A, in an example of the manufacturing method according to this embodiment, first, the first nonmagnetic layer (e.g. the bottom metallic layer 15) is formed (step S210). Then, the intermediate layer formation process (S10, i.e., steps S110, S120, and S130) is performed, and then the second nonmagnetic layer (e.g. the top metallic layer 17, i.e., a nonmagnetic layer) is formed. Thereby, the spacer layer 16s is formed.

Thus, in the manufacturing method according to this embodiment, the intermediate layer formation process (step S10) may be performed between: a process (step S210) that forms the first nonmagnetic layer provided between the first magnetic layer and the intermediate layer 16; and a process (step S220) that forms the second nonmagnetic layer provided between the second magnetic layer and the intermediate layer 16. That is, the manufacturing method according to this embodiment further includes a process that forms a nonmagnetic layer on the structure body 16 after the second treatment process.

That is, in this specific example, the structure body 16p is formed on the first magnetic layer in the structure body formation process (step S110). Furthermore, this manufacturing method further includes a process (step S220) that forms the second nonmagnetic layer on the structure body 16p having undergone the second treatment process.

As illustrated in FIG. 6B, in another example of the manufacturing method according to this embodiment, first, the first nonmagnetic layer (e.g. the bottom metallic layer 15) is formed (step S210), the structure body formation process (step S110) is performed, and the second nonmagnetic layer (e.g. the top metallic layer 17) is formed. Then, the first treatment process (step S120) and the second treatment process (step S130) are performed. Thereby, the spacer layer 16s is formed. This method forms the second nonmagnetic layer (e.g. the top metallic layer 17) after forming the structure body 16p, and performs the first treatment process and the second treatment process on the structure body 16p via the second nonmagnetic layer (e.g. the top metallic layer 17).

That is, in this specific example, the structure body 16p is formed on the first magnetic layer in the structure body formation process (step S110). In this specific example, a process (step S220) that forms the second nonmagnetic layer on the structure body 16p is further included, and the first treatment process (step S120) is performed after the process that forms the second nonmagnetic layer. Then, the second treatment process (step 5130) is further performed. That is, the manufacturing method according to this embodiment further includes a process that forms a nonmagnetic layer on the structure body before the first treatment process.

As described above, the first nonmagnetic layer and the second nonmagnetic layer can be replaced with each other. Therefore, the other manufacturing method according to this embodiment performs one of: a process (step S210) that forms the first nonmagnetic layer provided between the first magnetic layer and the intermediate layer 16; and a process (step S220) that forms the second nonmagnetic layer provided between the second magnetic layer and the intermediate layer 16.

An example of the structure body formation process (step S110) that forms the structure body 16p will now be described.

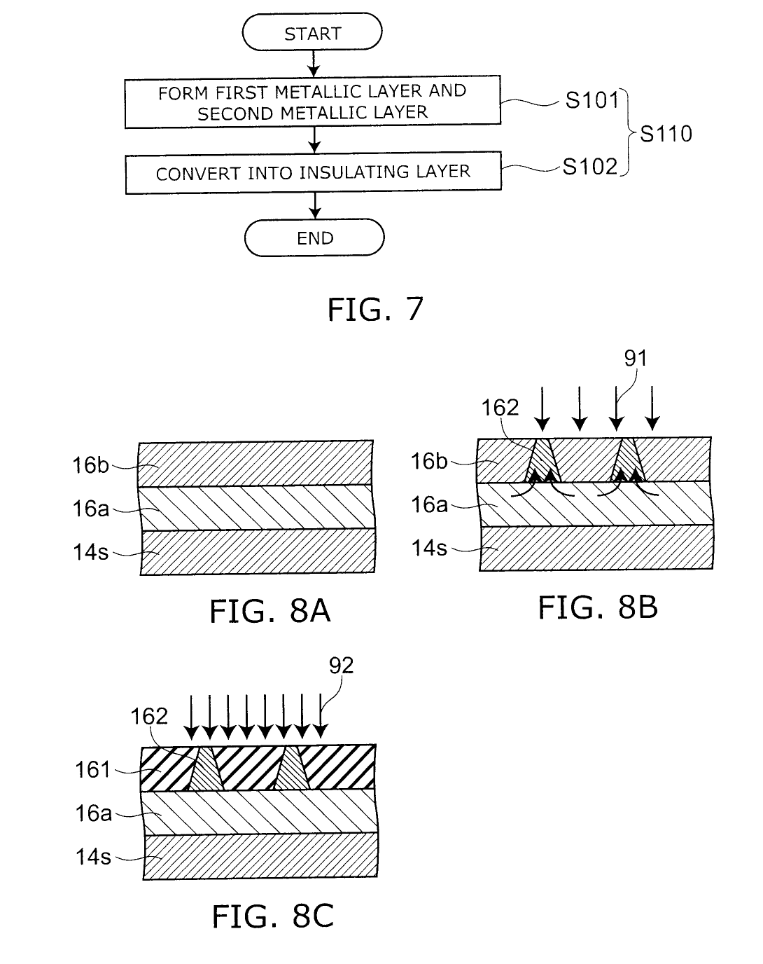

FIG. 7 is a flow chart illustrating part of the method for manufacturing a magneto-resistance effect element according to the first embodiment.

FIGS. 8A to 8C are sequential schematic cross-sectional views illustrating part of the method for manufacturing a magneto-resistance effect element according to the first embodiment.

That is, these drawings illustrate an example of the structure body formation process.

As illustrated in FIG. 7, the structure body formation process (step S110) includes: a film-formation process (step S101) that forms a first metallic film 16a that forms the conductive portion 162 and a second metallic film 16b that is converted into the insulating layer 161; and a conversion process (step S102) that converts the second metallic film 16b into the insulating layer 161 to form the structure body 16p.

That is, as illustrated in FIG. 8A, for example, the first metallic film 16a that forms the conductive portion 162 and the second metallic film 16b that forms the insulating layer 161 are stacked to be film-formed on a layer 14s including the first magnetic layer. The first metallic film 16a is, for example, Cu. The second metallic film 16b is Al. The second metallic film 16b may also be AlCu.

Then, for example, first, PIT (pre ion treatment) with an Ar ion beam 91 is performed as illustrated in FIG. 8B.

By the PIT, part of the first metallic film 16a on the lower side is drawn up toward the second metallic film 16b. Then, part of the first metallic film 16a penetrates through the second metallic film 16b to form the conductive portion 162.

Then, as illustrated in FIG. 8C, IAO (ion assisted oxidation) with an oxygen ion beam 92 is performed.

The IAO with oxygen gas (in this case, the oxygen ion beam 92) performs oxidative treatment on the first metallic film 16a and the second metallic film 16b.

The treatment with the oxygen ion beam 92 includes also oxidation treatment that introduces oxygen gas while delivering rare gas ions.

At this time, selective oxidation is performed based on the selection of materials used for the first metallic film 16a and the second metallic film 16b. That is, a material with a high oxidation generation energy is used for the first metallic film 16a that forms the conductive portion 162, and a material with a low oxidation generation energy is used for the second metallic film 16b that forms the insulating layer 161. In other words, a material difficult to oxidize and easy to reduce is used for the conductive portion 162, as compared to the insulating layer 161.

In this specific example, the second metallic film 16b which is Al is oxidized into Al₂O₃ to form the insulating layer 161. The first metallic film 16a which is Cu is oxidized relatively less easily, and most part thereof remains a metal. Thus, the first metallic film 16a not oxidized (oxidized at a low level) forms the conductive portion 162.

Thereby, the structure body 16p can be formed. However, the embodiment is not limited thereto. The structure body formation process may be any process that forms the structure body 16p including the insulating layer 161 and the conductive portion 162 penetrating through the insulating layer 161. For example, (Al₂O₃ insulator)-(metal granular film), which can form the structure body 16p in a self-assembly manner, may be used, and also a method may be used that deposits an AlCu alloy layer and then uses only plasma oxidation.

The first metallic film 16a may contain at least one selected from a group consisting of Cu, Au, and Ag.

The second metallic film 16b may contain at least one selected from a group consisting of Al, Si, Hf, Ti, Ta, Mo, W, Nb, Mg, Cr, and Zr.

Thereby, selective oxidation is performed based on the properties of the materials used for the first metallic film 16a and the second metallic film 16b. That is, a material with a high oxidation generation energy is used for the first metallic film 16a that forms the conductive portion 162, and a material with a low oxidation generation energy is used for the second metallic film 16b that forms the insulating layer 161. That is, a material difficult to oxidize and easy to reduce is used for the conductive portion 162, as compared to the insulating layer 161. Thereby, the structure body 16p can be formed more easily.

Furthermore, as mentioned above, the conversion process (step S102) may include at least one of: a process (e.g. the PIT mentioned above) that irradiates the second metallic film with at least one of ions and plasma containing at least one element selected from a group consisting of Ar, Xe, He, Ne, and Kr; and a process (e.g. the IAO mentioned above) that irradiates the second metallic film with at least one of ions and plasma containing at least one of O (oxygen) and N (nitrogen).

Practical examples of the method for manufacturing a magneto-resistance effect element according to this embodiment will now be described.

### First Practical Example

The configuration of the magneto-resistance effect film 10 in a magneto-resistance effect element of a first practical example is as follows.

Hereinbelow, the thickness of each layer is expressed in nanometers (nm), and the composition of an alloy is expressed in atomic percents (atomic %). Furthermore, for example, the expression of “Ta [5 nm]/Ru [2 nm]” means a configuration in which Ru with a thickness of 2 nm is provided on Ta with a thickness of 5 nm.
the bottom electrode 11
the underlayer 12: Ta [1 nm]/Ru [2 nm]
the pinning layer 13: Ir₂₂Mn_{78 [}7 nm]
the pinned layer 14: CO₇₅Fe_{25 [}4.35 nm]/Ru [0.9 nm]/Fe₅₀CO_{50 [}1.8 nm]/Cu [0.25 nm]/Fe₅₀CO_{50 [}1.8 nm]
the bottom metallic layer 15: Cu [0.6 nm]
the intermediate layer 16: the insulating layer 161 of Al₂O₃ and the conductive portion 162 of Cu (AlCu [1 nm])
the top metallic layer 17: Cu [0.25 nm]
the free layer 18: CO₆₀Fe_{40 [}2 nm]/Ni₉₅Fe_{5 [}3.5 nm]
the cap layer 19: Cu [1 nm]/Ru [10 nm]
the top electrode 20

In the above, after the bottom electrode 11, the underlayer 12, the pinning layer 13, the pinned layer 14, and the bottom metallic layer 15 were successively formed, the structure body 16p was formed by film-forming Cu, then film-forming Al, and then performing the PIT and the IAO. After that, the AIT and the AO were performed on the structure body 16p to form the intermediate layer 16. After that, the top metallic layer 17, the free layer 18, the cap layer 19, and the top electrode 20 were successively formed to form a magneto-resistance effect element 101a of the first practical example. This manufacturing method uses the method illustrated in FIG. 6A.

In the AIT in the first practical example, Ar plasma is used, the RF power P_{AIT} in the AIT is 20 watts (W), and the treatment time is 120 seconds. In the AO, exposure to gas containing oxygen (oxygen exposure with a natural oxygen flow) is used, the flow rate of the oxygen gas at this time is 10 sccm, and the treatment time is 300 seconds.

An Ar ion beam was used for the PIT. Oxygen treatment using an Ar ion beam was used for the TAO.

### First Comparative Example

The configuration of the magneto-resistance effect film 10 in a magneto-resistance effect element 109a of a first comparative example is the same as the first practical example, but in the first comparative example, after the structure body 16p is formed, neither the AIT nor the AO is performed. That is, after the bottom electrode 11, the underlayer 12, the pinning layer 13, the pinned layer 14, and the bottom metallic layer 15 were successively formed, the structure body 16p was formed by film-forming Cu, then film-forming Al, and then performing the PIT and the IAO; and then the top metallic layer 17, the free layer 18, the cap layer 19, and the top electrode 20 were successively formed to form the magneto-resistance effect element 109a of the first comparative example.

### Second Comparative Example

The configuration of the magneto-resistance effect film 10 in a magneto-resistance effect element 109b of a second comparative example is the same as the first practical example, but in the second comparative example, after the structure body 16p is formed, only the AIT is performed and the AO is not performed. That is, after the bottom electrode 11, the underlayer 12, the pinning layer 13, the pinned layer 14, and the bottom metallic layer 15 were formed, the structure body 16p was formed by film-forming Cu, then film-forming Al, and then performing the PIT and the IAO; and then the AIT was performed on the structure body 16p to form the intermediate layer 16. After that, the top metallic layer 17, the free layer 18, the cap layer 19, and the top electrode 20 were successively formed to form the magneto-resistance effect element 109b of the second comparative example. The conditions of the AIT in the second comparative example are the same as the first practical example.

### Third Comparative Example

The configuration of the magneto-resistance effect film 10 in a magneto-resistance effect element 109c of a third comparative example is the same as the first practical example, but in the third comparative example, after the structure body 16p is formed, only the AO is performed and the AIT is not performed. That is, after the bottom electrode 11, the underlayer 12, the pinning layer 13, the pinned layer 14, and the bottom metallic layer 15 were formed, the structure body 16p was formed by film-forming Cu, then film-forming Al, and then performing the PIT and the IAO; then the AO was performed on the structure body 16p; and after that, the top metallic layer 17, the free layer 18, the cap layer 19, and the top electrode 20 were successively formed to form the magneto-resistance effect element 109c of the third comparative example. The conditions of the AO in the third comparative example are the same as the first practical example.

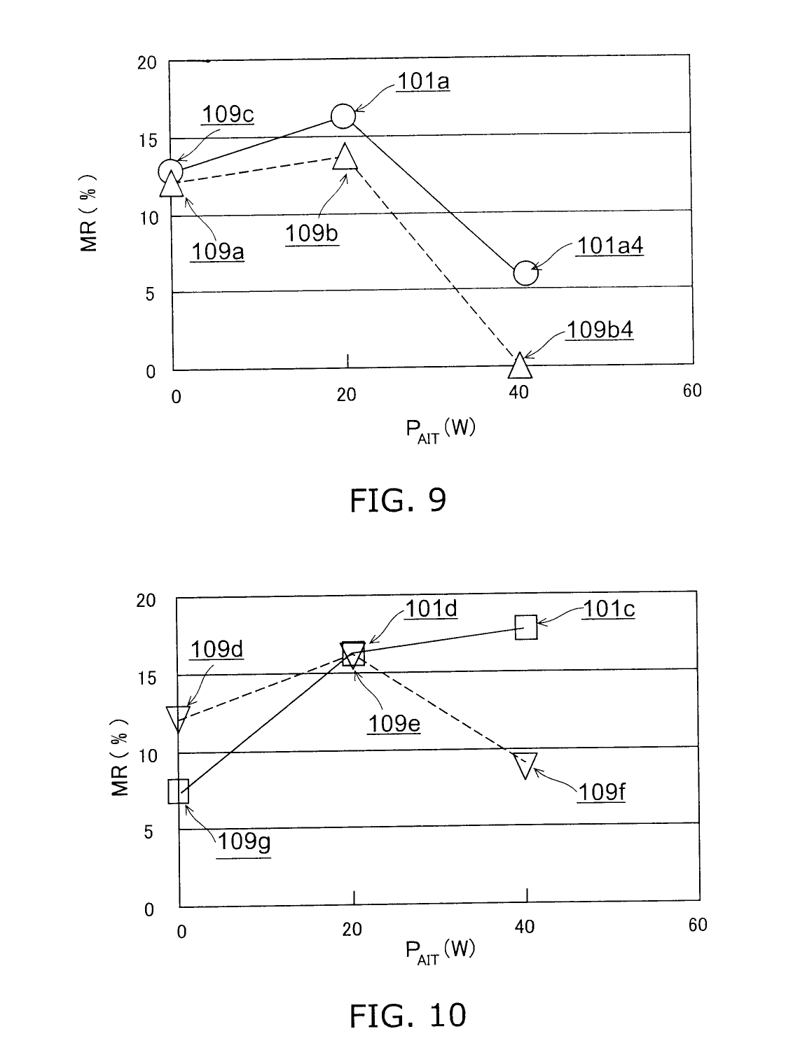

FIG. 9 is a graph illustrating characteristics of the magneto-resistance effect elements according to the practical example of the embodiment and the comparative examples.

In the drawing, the horizontal axis represents the RF power P_{AIT} in the AIT, and the vertical axis represents the MR ratio (MR). The triangle mark represents characteristics under the condition of not performing the AO, and the circular mark represents characteristics under the condition of performing the AO. The condition that the RF power P_{AIT} is zero corresponds to not performing the AIT.

As illustrated in FIG. 9, in the magneto-resistance effect element 109a of the first comparative example (the AIT is not performed, that is, the RF power P_{AIT} is zero, and the AO is not performed, either), the MR ratio (MR) was 12.1%. The element resistance R^{A} at this time was 700 mΩ·μm².

In the magneto-resistance effect element 109b of the second comparative example in which only the AIT was performed, the MR ratio (MR) was 13.7%. In the second comparative example, although the MR ratio is higher than the first comparative example, the degree of increase (difference in MR ratio) is 1.6%, which is small. The element resistance RA of the magneto-resistance effect element 109b was 400 mΩ·μm².

Furthermore, in the magneto-resistance effect element 109c of the third comparative example in which only the AO was performed, the MR ratio (MR) was 12.8%. Also in the third comparative example, although the MR ratio is higher than the first comparative example, the degree of increase (difference in MR ratio) is 0.7%, which is still small. The element resistance RA of the magneto-resistance effect element 109c was 700 mΩ·μm².

In contrast, in the magneto-resistance effect element 101a of the first practical example in which the AIT with an RF power P_{AIT} of 20 W and the AO were performed, the MR ratio (MR) was 16.3%. The element resistance RA of the magneto-resistance effect element 101a is 500 mΩ·μm².

When the first to third comparative examples and the first practical example are compared, the first practical example provides a significantly higher MR ratio than all of the first to third comparative examples.

Furthermore, the degree of increase in MR ratio (difference in MR ratio) of the first practical example to the first comparative example is 4.2%. That is, the first practical example significantly increases the MR ratio from the second comparative example and the third comparative example. More specifically, the degree of increase in MR ratio in the second comparative example in which only the AIT is performed is 1.6%, and the degree of increase in MR ratio in the third comparative example in which only the AO is performed is 0.7%; and even if they are totaled up, the degree of increase in MR ratio is only 2.3%.

In contrast, in the first practical example in which the AIT and the AO were performed in combination, the degree of increase in MR ratio is 4.3%, and the MR ratio is increased by about twice the total of those of the second comparative example and the third comparative example, i.e., 2.3%.

That is, the manufacturing method according to this embodiment that uses the AIT and the AO in combination provides such a high MR ratio as cannot be expected from the effects obtained from performing only the AIT and performing only the AO as in the cases of the second comparative example and the third comparative example.

This is a phenomenon that is found out first in these experiments by the inventors, and the manufacturing method according to this embodiment is invented based on this newly obtained knowledge.

In the case where the AIT and the AO are performed in combination, a magneto-resistance effect element 101a4 in which the RF power P_{AIT} of the AIT is 40 W has a decreased MR ratio of about 5%. Furthermore, a magneto-resistance effect element 109b4 in which the AO is not performed and the RF power P_{AIT} of the AIT is 40 W has an MR ratio of zero. Thus, an excessively large RF power P_{AIT} of the AIT decreases the MR ratio. This is probably because the AIT with an excessively large RF power P_{AIT} degrades the insulation properties of the insulating layer 161 of the structure body 16p. Also in the case where the RF power P_{AIT} is thus too large, performing the AO after the AIT increases the MR ratio. Thus, the insulating layer 161 degraded by the excessively strong AIT is probably recovered by performing the AO after the AIT, and this may explain the effects mentioned above in the case where the AIT and the AO are performed in combination.

In this specific example, the RF power P_{AIT} of the AIT is set to, for example, 20 W. Thus, in the manufacturing method according to this embodiment, the conditions of the AIT to be used are properly set based on the combination with the AO treatment, and thereby the highest MR ratio is obtained.

### Second Practical Example

The configuration of the magneto-resistance effect film 10 in a magneto-resistance effect element of a second practical example is similar to the magneto-resistance effect element 101a of the first practical example. However, in the case of the second practical example, the method illustrated in FIG. 6B is used. That is, after the bottom electrode 11, the underlayer 12, the pinning layer 13, the pinned layer 14, and the bottom metallic layer 15 are successively formed, the structure body 16p is formed by film-forming Cu, then film-forming Al, and then performing the PIT and the IAO; then the top metallic layer 17 is formed; then the AIT and the AO are performed on the structure body 16p via the top metallic layer 17 to form the intermediate layer 16; and after that the free layer 18, the cap layer 19, and the top electrode 20 are successively formed to form the magneto-resistance effect element of the second practical example.

Thus, also by the method in which the formation of the structure body 16p is followed by performing the AIT and the AO on the structure body 16p via the top metallic layer 17 to form the intermediate layer 16, a high MR ratio equal to that of the first practical example is obtained.

The first practical example and the first to third comparative examples performed oxygen treatment using an Ar ion beam as the IAO in forming the structure body 16p. On the other hand, the result of performing oxygen treatment using a Xe ion beam as the IAO will now be described.

### Third Practical Example

The configuration of the magneto-resistance effect film 10 in a magneto-resistance effect element 101c of a third practical example is the same as the first practical example, but oxygen treatment using a Xe ion beam is used as the IAO used in forming the structure body 16p, and the RF power P_{AIT} in the AIT is 40 W. The rest is the same as the first practical example.

### Fourth Comparative Example

The configuration of the magneto-resistance effect film 10 in a magneto-resistance effect element 109d of a fourth comparative example is the same as the third practical example, but in the fourth comparative example, neither the AIT nor the AO is performed after the structure body 16p is formed.

### Fifth Comparative Example

The configuration of the magneto-resistance effect film 10 in a magneto-resistance effect element 109e of a fifth comparative example is the same as the third practical example, but in the fifth comparative example, only the AIT is performed and the AO is not performed after the structure body 16p is formed. The RF power P_{AIT} of the AIT in the fifth comparative example is 20 W.

### Sixth Comparative Example

The configuration of the magneto-resistance effect film 10 in a magneto-resistance effect element 109f of a sixth comparative example is the same as the third practical example, but in the sixth comparative example, only the AIT is performed and the AO is not performed after the structure body 16p is formed. The RF power P_{AIT} of the AIT in the sixth comparative example is 40 W, which is the same as the third practical example.

### Seventh Comparative Example

The configuration of the magneto-resistance effect film 10 in a magneto-resistance effect element 109g of a seventh comparative example is the same as the third practical example, but in the seventh comparative example, only the AO is performed and the AIT is not performed after the structure body 16p is formed. The conditions of the AO in the seventh comparative example are the same as the third practical example.

Other than them, also a magneto-resistance effect element 101d was fabricated in which the AIT and the AO are performed similarly to the third practical example, but the RF power P_{AIT} of the AIT is 20 W.

FIG. 10 is a graph illustrating characteristics of the magneto-resistance effect elements according to the practical example of the embodiment and the comparative examples.

That is, the drawing illustrates characteristics of the magneto-resistance effect element 101c of the third practical example, the magneto-resistance effect elements 109d, 109e, 109f, and 109g of the fourth to seventh comparative examples, and the magneto-resistance effect element 101d.

In the drawing, the horizontal axis represents the RF power P_{AIT} in the AIT, and the vertical axis represents the MR ratio (MR). The inverted triangle mark represents characteristics under the condition of not performing the AO, and the square mark represents characteristics under the condition of performing the AO. The condition that the RF power P_{AIT} is zero corresponds to not performing the AIT.

As illustrated in FIG. 10, the MR ratio of the magneto-resistance effect element 109d of the fourth comparative example in which neither the AIT nor the AO is performed after the structure body 16p is formed is about 12%, which is low.

The MR ratio of the magneto-resistance effect element 109e of the fifth comparative example in which the AO is not performed, the AIT is performed, and the RF power P_{AIT} of the AIT is 20% is about 16%, which is relatively high.

The MR ratio of the magneto-resistance effect element 109f of the sixth comparative example in which the AO is not performed, the AIT is performed, and the RF power P_{AIT} of the AIT is 40 W is about 9%, which is greatly lower than that of the magneto-resistance effect element 109e and is very low.

The MR ratio of the magneto-resistance effect element 109g of the seventh comparative example in which the AIT was not performed and the AO was performed is about 7.5%, which is very low.

In contrast, the MR ratio of the magneto-resistance effect element 101c of the third practical example in which the AIT and the AO are performed in combination and the RF power P_{AIT} of the AIT is 40 W is about 17.5%, which is higher than those of all of the fourth to seventh comparative examples. Thus, the manufacturing method according to this embodiment can manufacture a magneto-resistance effect element with an increased MR ratio.

The MR ratio of the magneto-resistance effect element 109f of the sixth comparative example in which the AIT with an RF power P_{AIT} of 40 W is performed and the AO is not performed is significantly low. On the other hand, in the third practical example, although the AIT of the same conditions is used, a high MR ratio is achieved by performing the AO. From this, it is probable that the AO has recovered the insulation properties of the insulating layer 161 from the deterioration caused by the AIT and thereby the MR ratio has increased.

The magneto-resistance effect element 109e of the fifth comparative example in which the AO was not performed and the AIT with a small RF power P_{AIT} (20 W) was performed obtains a relatively high MR ratio (about 16%). Thus, in the case where only the AIT is performed, controlling the RF power provides a relatively high MR ratio. However, performing the AIT and the AO in combination like the third practical example provides a still higher MR ratio than the fifth comparative example, and this is knowledge obtained for the first time.

In the case where the AIT and the AO are performed in combination, also the magneto-resistance effect element 101d in which the AIT power P_{AIT} is 20 W obtains a relatively high MR ratio (about 16%), which is not below the MR ratio of the magneto-resistance effect element 109e of the fifth comparative example.

Thus, in the manufacturing method according to this embodiment, the conditions of the AIT to be used are properly set based on the combination with the AO treatment, and thereby the highest MR ratio is obtained.

That is, in the case where the AO is not performed and only the AIT is performed, the MR ratio significantly decreases if the RF power P_{AIT} is not appropriate (for example, if it is too large like 40 W etc.); on the other hand, this embodiment combines the AIT and the AO and therefore allows a very wide range of RF powers P_{AIT} that provide high MR ratios. This means that performing the AIT and the AO in combination expands the range of appropriate treatment conditions of the AIT. Thus, the manufacturing method according to this embodiment can expands the manufacturing margin and produce high-performance magneto-resistance effect elements sta bly.

In the manufacturing method according to this embodiment, the treatment conditions (e.g. the RF power P_{AIT}, MT/time, etc.) of the AIT are set so that the MR ratio may be highest. Furthermore, as illustrated in FIG. 9 and FIG. 10, appropriate conditions of the AIT are appropriately selected in accordance with conditions (e.g. gas type used in the IAO, etc.) in forming the structure body 16p, for example.

That is, in the case where, for example, the PIT and the IAO are used and oxygen gas treatment using an Ar ion beam is used as the IAO in the formation of the structure body 16p (e.g. the first practical example of FIG. 9), the RF power P_{AIT} of the AIT is set to, for example, about 20 W (plus minus 20%).

Furthermore, in the case where, for example, the PIT and the IAO are used and oxygen gas treatment using a Xe ion beam is used as the IAO in the formation of the structure body 16p (e.g. the third practical example of FIG. 10), the RF power P_{AIT} of the AIT is set to, for example, about 40 W (plus minus 20%).

In view of the variation of various manufacturing conditions and the like, the condition of an appropriate RF power P_{AIT} in the AIT may be changed within a range of about plus or minus 20% of the values mentioned above.

An example of the configuration of the magneto-resistance effect element to which the method for manufacturing a magneto-resistance effect element according to this embodiment is applied will now be described with reference to FIG. 3.

The bottom electrode 11 is an electrode for conducting a current in the direction perpendicular to the spin valve film. By applying a voltage between the bottom electrode 11 and the top electrode 20, a current flows through the interior of the spin valve film along the direction perpendicular to the spin valve film. The magnetism can be detected by using this current to detect a change in resistance due to the magneto-resistance effect. A metallic layer with a relatively small electric resistance is used for the bottom electrode 11 in order to conduct a current through the magneto-resistance effect element. NiFe, Cu, and the like are used for the bottom electrode 11.

The underlayer 12 may be partitioned into, for example, a buffer layer 12a (not illustrated) and a seed layer 12b (not illustrated). The buffer layer 12a absorbs the roughness of the surface of the bottom layer 11, for example. The seed layer 12b controls the crystal orientation and the crystal particle size of the spin valve film film-formed thereon, for example.

Ta, Ti, W, Zr, Hf, and Cr or an alloy thereof may be used as the buffer layer 12a. The buffer layer 12a has a film thickness of preferably about 2 nm to 10 nm, more preferably about 3 nm to 5 nm. An excessively small thickness of the buffer layer 12a negates the buffer effect. On the other hand, an excessively large thickness of the buffer layer 12a increases the series resistance that does not contribute to the MR ratio. In the case where the seed layer 12b film-formed on the buffer layer 12a has a buffer effect, the buffer layer 12a need not necessarily be provided. Ta with a thickness of 3 nm may be used as a preferable example.

The seed layer 12b may be made of a material that can control the crystal orientation of a layer film-formed thereon. As the seed layer 12b, a metal layer having the fcc structure (face-centered cubic structure), the hcp structure (hexagonal close-packed structure), or the bcc (body-centered cubic structure) and the like are preferably used. For example, by using Ru having the hcp structure or NiFe having the fcc structure as the seed layer 12b, the crystal orientation of the spin valve film thereon can be made the fcc (111) orientation. Furthermore, the crystal orientation of the pinning layer 13 (e.g. PtMn) can be made the regularized fct structure (face-centered tetragonal structure) or bcc structure (body-centered cubic structure) (110) orientation.

Other than them, also Cr, Zr, Ti, Mo, Nb, and W, an alloy layer thereof, and the like may be used for the seed layer 12b.

The seed layer 12b has a film thickness of preferably 1 nm to 5 nm, more preferably 1.5 nm to 3 nm in order to sufficiently utilize the function as the seed layer 12b that improves crystal orientation. Ru with a thickness of 2 nm may be used as a preferable example.

The crystal orientation of the spin valve film and the pinning layer 13 can be measured by X-ray diffraction. The half width of the rocking curve at the fcc (111) peak of the spin valve film, or the fct (111) peak or the bcc (110) peak of the pinning layer 13 (PtMn) may be 3.5 degrees to 6 degrees; thus, a good orientation can be obtained. The dispersion angle of this orientation can be distinguished also by diffraction spots obtained with a cross-section TEM.

As the seed layer 12b, a NiFe-based alloy (e.g. NiₓFe₁₀₀₋ₓ (x=90 to 50, preferably 75 to 85) or (NiₓFe₁₀₀₋ₓ)_{100-y}X_{y} (X═Cr, V, Nb, Hf, Zr, or Mo) provided with nonmagnetism properties by adding a third element X to NiFe) may be used in place of Ru. Using the NiFe-based seed layer 12b provides a good crystal orientation relatively easily, and can yield a half width of the rocking curve measured similarly to the above of 3 degrees to 5 degrees.

The seed layer 12b has not only the function of improving the crystal orientation but also the function of controlling the crystal particle size of the spin valve film. Specifically, the crystal particle size of the spin valve film can be controlled to 5 nm to 40 nm, and a high MR ratio can be achieved without causing a variation in characteristics, even if the magneto-resistance effect element has a small size.

The crystal particle size herein can be distinguished by the particle size of the crystal particle formed on the seed layer 12b, and can be determined with a cross-section TEM and the like. In the case of a bottom-pinned spin valve film in which the pinned layer 14 is located below the intermediate layer 16, it can be distinguished by the crystal particle size of the pinning layer 13 (antiferromagnetic layer) or the pinned layer 14 (magnetization fixed layer) formed on/above the seed layer 12b.

In a reproducing head adapted to high recording density, the element size is 100 nm or less, for example. A large ratio of the crystal particle size to the element size causes a variation in characteristics of the element. It is not preferable that the spin valve film has a crystal particle size of more than 40 nm. Specifically, the crystal particle size is preferably within a range of 5 nm to 40 nm, more preferably within a range of 5 nm to 20 nm.

A small number of crystal particles per element area may cause a variation in characteristics due to the smallness of the number of crystals. Therefore, increasing the crystal particle size is not preferable so much. In particular, increasing the crystal particle size is not preferable so much in the CCP-CPP element including the conductive portion 162 in the insulating layer 161. On the other hand, an excessively small crystal particle size generally makes it difficult to keep a good crystal orientation. A preferable range of the crystal particle size in view of these upper limit and lower limit of the crystal particle size is 5 nm to 20 nm.

However, the element size may be 100 nm or more in MRAM uses and the like, and there are cases where even a large crystal particle size of about 40 nm poses little problem. That is, by using the seed layer 12b, an increased crystal particle size may not cause a problem.

To obtain the crystal particle size of 5 nm to 20 nm described above, the seed layer 12b is preferably made of Ru (with a thickness of 2 nm) or a (NiₓFe₁₀₀₋ₓ)_{100-y}X_{y} (X═Cr, V, Nb, Hf, Zr, or Mo) layer, where in the latter case, the composition y of the third element X is preferably about 0 to 30 (including the case of y being 0).

On the other hand, to use increased crystal particle sizes of more than 40 nm, a still larger amount of the additive element is preferably used. In the case where the seed layer 12b is made of, for example, NiFeCr, it is preferable to use a NiFeCr layer with the bcc structure, using a composition with a Cr content of about 35% to 45% to produce the fcc-bcc boundary phase.

As described above, the seed layer 12b has a film thickness of preferably about 1 nm to 5 nm, more preferably 1.5 nm to 3 nm. An excessively small thickness of the seed layer 12b negates the effects of crystal orientation control and the like. On the other hand, an excessively large thickness of the seed layer 12b causes an increase in series resistance, and may further cause roughness of the interface of the spin valve film.

The pinning layer 13 has the function of providing a ferromagnetic layer that forms the pinned layer 14 film-formed thereon with a unidirectional anisotropy to fix the magnetization. As the material of the pinning layer 13, an antiferromagnetic material such as PtMn, PdPtMn, IrMn, and RuRhMn may be used. Among them, IrMn is advantageous as the material of a head adapted to high recording density. IrMn can apply a unidirectional anisotropy with a smaller film thickness than PtMn, and is suitable for narrowing gap which is necessary for high density recording.

To provide the unidirectional anisotropy with a sufficient strength, the film thickness of the pinning layer 13 is appropriately set. In the case where the pinning layer 13 is made of PtMn or PdPtMn, the film thickness is preferably about 8 nm to 20 nm, more preferably 10 nm to 15 nm. In the case where the pinning layer 13 is made of IrMn, a unidirectional anisotropy can be provided even when a smaller film thickness than PtMn and the like is used. In this case, the film thickness is preferably 3 nm to 12 nm, more preferably 4 nm to 10 nm. IrMn with a thickness of 7 nm may be used as a preferable example.

A hard magnetic layer may be used as the pinning layer in place of the antiferromagnetic layer. As the hard magnetic layer, for example, CoPt (Co=50% to 85%), (COₓPt₁₀₀₋ₓ)_{100-y}Cr_{y} (x=50 to 85, y=0 to 40), and FePt (Pt=40% to 60%) may be used. Since the hard magnetic layer (in particular, CoPt) has a relatively small specific resistance, increases in series resistance and sheet resistivity can be suppressed.

Furthermore, in the case where materials having greatly different coercive forces are used for the pinned layer 14 and the free layer 18, the pinning layer 13 may be omitted. This is the case where the pinned layer 14 itself is a high coercive force material such as CoPt (Co=50% to 85%), (COₓPt₁₀₀₋ₓ)_{100-y}Cr_{y} (x=50 to 85, y=0 to 40), and FePt (Pt=40% to 60%), and the free layer 18 is a low coercive force material such as a NiₓFe₁₀₀₋ₓ alloy (x=75 to 95), a Niₓ(Fe_{y}CO_{100-y})₁₀₀₋ₓ alloy (x=75 to 95, y=0 to 100), and a COₓFe₁₀₀₋ₓ alloy (x=85 to 95).

A preferable example of the pinned layer 14 is a synthetic pinned layer formed of the bottom pinned layer 141 (e.g. Co₉₀Fe₁₀ with a thickness of 3.5 nm), the magnetic coupling layer 142 (e.g. Ru), and the top pinned layer 143 (e.g. (Fe₅₀CO₅₀ with a thickness of 1 nm)/(Cu with a thickness of 0.25 nm)/(Fe₅₀CO₅₀ with a thickness of 1 nm)/(Cu with a thickness of 0.25 nm)/(Fe₅₀CO₅₀ with a thickness of 1 nm)). The pinning layer 13 (e.g. IrMn) and the bottom pinned layer 141 immediately thereon are coupled by magnetic exchange so as to have a unidirectional anisotropy. The bottom pinned layer 141 and the top pinned layer 143 on/below the magnetic coupling layer 142 are magnetically coupled strongly so that the directions of magnetization thereof may be antiparallel to each other.

As the material of the bottom pinned layer 141, for example, a COₓFe₁₀₀₋ₓ alloy (x=0 to 100), NiₓFe₁₀₀₋ₓ alloy (x=0 to 100), or a material obtained by adding a nonmagnetic element thereto may be used. Furthermore, also a single element such as Co, Fe, and Ni or an alloy thereof may be used as the material of the bottom pinned layer 141.

The bottom pinned layer 141 preferably has a magnetic film thickness (saturated magnetization Bs×film thickness t, i.e., the product Bs·t) nearly equal to the magnetic film thickness of the top pinned layer 143. In other words, it is preferable that the magnetic film thickness of the top pinned layer 143 corresponds to the magnetic film thickness of the bottom pinned layer 141. As an example, in the case where the top pinned layer 143 has a structure of (Fe₅₀CO₅₀ with a film thickness of 1 nm)/(Cu with a film thickness of 0.25 nm)/(Fe₅₀CO₅₀ with a film thickness of 1 nm)/(Cu with a film thickness of 0.25 nm)/(Fe₅₀CO₅₀ with a film thickness of 1 nm), since the saturated magnetization of FeCo in a thin film configuration is about 2.2 T (tesla), the magnetic film thickness is 2.2 T×3 nm=6.6 Tnm. Since the saturated magnetization of CO₉₀Fe₁₀ is about 1.8 T, the film thickness t of the bottom pinned layer 141 that provides a magnetic film thickness equal to the above is 6.6 Tnm/1.8 T=3.66 nm. Therefore, CO₉₀Fe₁₀ with a film thickness of about 3.6 nm is preferably used. In the case where IrMn is used as the pinning layer 13, the bottom pinned layer 141 preferably has a composition in which Fe is contained a little more than CO₉₀Fe₁₀.

The magnetic layer used for the bottom pinned layer 141 preferably has a film thickness of about 1.5 nm to 4 nm. This is based on the view of the unidirectional anisotropy magnetic field strength by the pinning layer 13 (e.g. IrMn) and the antiferromagnetic coupling magnetic field strength of the bottom pinned layer 141 and the top pinned layer 143 via the magnetic coupling layer 142 (e.g. Ru). An excessively small thickness of the bottom pinned layer 141 decreases the MR ratio. On the other hand, an excessively large thickness of the bottom pinned layer 141 makes it difficult to obtain a sufficient unidirectional anisotropy magnetic field necessary for device operation. CO₇₅Fe₂₅ with a film thickness of 3.6 nm is given as a preferable example.

The magnetic coupling layer 142 (e.g. Ru) has the function of causing an antiferromatic coupling between the magnetic layers thereon and therebelow (the bottom pinned layer 141 and the top pinned layer 143) to form a synthetic pinned structure. The Ru layer as the magnetic coupling layer 142 preferably has a film thickness of 0.8 nm to 1 nm. Any material other than Ru may be used that causes a sufficient antiferromagnetic coupling between the magnetic layers thereon and therebelow. Also a film thickness of 0.3 nm to 0.6 nm which corresponds to the first peak of the RKKY (Runderman-Kittel-Kasuya-Yoshida) coupling may be used instead of a film thickness of 0.8 nm to 1 nm which corresponds to the second peak of the RKKY coupling. Ru with a film thickness of 0.9 nm, which provides a coupling with higher reliability stably, is given as an example of the magnetic coupling layer 142.

As an example of the top pinned layer 143, a magnetic layer such as (Fe₅₀CO₅₀ with a thickness of 1 nm)/(Cu with a thickness of 0.25 nm)/(Fe₅₀CO₅₀ with a thickness of 1 nm)/(Cu with a thickness of 0.25 nm)/(Fe₅₀CO₅₀ with a thickness of 1 nm) may be used. The top pinned layer 143 constitutes part of the spin dependent scattering unit. The top pinned layer 143 is a magnetic layer contributing directly to the MR effect, and both the material and the film thickness thereof are important in order to obtain a high MR ratio. In particular, the magnetic material located at the interface with the intermediate layer 16 is important in view of the contribution to the spin dependent interface scattering.

Effects of using the Fe₅₀CO₅₀ having the bcc structure used here as the top pinned layer 143 will now be described. In the case where a magnetic material having the bcc structure is used as the top pinned layer 143, since the spin dependent interface scattering effect is great, a high MR ratio can be achieved. As an FeCo-based alloy having the bcc structure, FeₓCO₁₀₀₋ₓ (x=30 to 100) or a material obtained by adding an additive element to FeₓCO₁₀₀₋ₓ is given. Among them, Fe₄₀CO₆₀ to Fe₆₀Co₄₀ which have various characteristics are given as a material easy to use.

In the case where a magnetic layer having the bcc structure which easily achieves a high MR ratio is used as the top pinned layer 143, the total film thickness of the magnetic layer is preferably 1.5 nm or more in order to retain the bcc structure stably. Since the metallic material used for the spin valve film has the fcc structure or the fct structure in many cases, only the top pinned layer 143 may have the bcc structure. Accordingly, an excessively small film thickness of the top pinned layer 143 makes it difficult to retain the bcc structure stably and prevents obtaining a high MR ratio.

In this specific example, Fe₅₀CO₅₀ including an extremely thin Cu stack is used as the top pinned layer 143. Here, the top pinned layer 143 is formed of FeCo with a total film thickness of 3 nm and Cu with a film thickness of 0.25 nm stacked for each FeCo with a film thickness of 1 nm, and the total film thickness is 3.5 nm.

The top pinned layer 143 preferably has a film thickness of 5 nm or less in order to obtain a large pinned fixed magnetic field. To achieve both the large pinned fixed magnetic field and the stability of the bcc structure, the top pinned layer 143 having the bcc structure preferably has a film thickness of about 2.0 nm to 4 nm.

For the top pinned layer 143, a CO₉₀Fe₁₀ alloy having the fcc structure or a Co alloy having the hcp structure, which are widely used for magneto-resistance effect elements, may be used in place of the magnetic material having the bcc structure. As the top pinned layer 143, a simple substance metal such as Co, Fe, and Ni and all alloy materials containing one element of them may be used. In regard to the magnetic material of the top pinned layer 143, an FeCo alloy material having the bcc structure, a Co alloy containing 50% or more Co, and a Ni alloy containing 50% or more Ni are advantageous in this order for obtaining a high MR ratio.

For example, a structure in which a magnetic layer (FeCo layer) and a nonmagnetic layer (extremely thin Cu layer) are alternately stacked may be used as the top pinned layer 143. The top pinned layer 143 with such a structure can enhance the spin dependent scattering effect called the “spin dependent bulk scattering effect” by means of the extremely thin Cu layer.

The “spin dependent bulk scattering effect” is used as a word constituting a pair together with the spin dependent interface scattering effect. The spin dependent bulk scattering effect is a phenomenon in which the MR effect appears in a magnetic layer. The spin dependent interface scattering effect is a phenomenon in which the MR effect appears at the interface between a spacer layer and a magnetic layer.

The enhancement of the bulk scattering effect by a stack structure of a magnetic layer and a nonmagnetic layer will now be described.

In the CCP-CPP element, since a current is confined near the intermediate layer 16, the contribution of the resistance in the vicinity of the interface of the intermediate layer 16 is very large. That is, the resistance at the interface between the intermediate layer 16 and the magnetic layer (the pinned layer 14 and the free layer 18) largely accounts for the resistance of the entire magneto-resistance effect element. This indicates that the contribution of the spin dependent interface scattering effect is very large and important in the CCP—CPP element. In other words, the selection of the magnetic material located at the interface of the intermediate layer 16 is important as compared to cases of conventional CPP elements. This is a reason for using the FeCo alloy layer having the bcc structure which has a large spin dependent interface scattering effect as the top pinned layer 143.

However, also using a material with a large bulk scattering effect cannot be ignored, but is still important in order to obtain a higher MR ratio. The film thickness of the extremely thin Cu layer for obtaining the bulk scattering effect is preferably 0.1 nm to 1 nm, more preferably 0.2 nm to 0.5 nm. An excessively small film thickness of the Cu layer weakens the effect of enhancing the bulk scattering effect. An excessively large film thickness of the Cu layer may reduce the bulk scattering effect and also weakens the magnetic coupling between the upper and lower magnetic layers via the nonmagnetic Cu layer, leading to only insufficient characteristics of the pinned layer 14. Accordingly, this specific example used Cu with a film thickness of 0.25 nm.

As the material of the nonmagnetic layer between the magnetic layers, Hf, Zr, Ti, Al, and the like may be used in place of Cu. On the other hand, in the case where these extremely thin nonmagnetic layers are interposed, the magnetic layer of FeCo or the like has a film thickness of preferably 0.5 nm to 2 nm, more preferably about 1 nm to 1.5 nm, for one layer.

As the top pinned layer 143, a layer of an alloy of FeCo and Cu may be used in place of the alternately stacked structure of the FeCo layer and the Cu layer. Examples of such FeCoCu alloys include (FeₓCo₁₀₀₋ₓ)_{100-y}Cu_{y} (x=30 to 100, y=about 3 to 15), but other composition ranges may be used. Here, another element such as Hf, Zr, Ti, and Al may be used as an element added to FeCo in place of Cu.

For the top pinned layer 143, also a single layer film made of Co, Fe, or Ni or an alloy material thereof may be used. For example, as the top pinned layer 143 with a simplest structure, a CO₉₀Fe₁₀ single layer with a thickness of 2 nm to 4 nm, which has been widely used so far, may be used. Another element may be added to the material.

Next, the film configuration of the spacer layer 16s will now be described. The bottom metallic layer 15 is a residual layer resulting from the use as a source of the material of the conductive portion 162, and may not remain necessarily in the end.

The intermediate layer 16 includes the insulating layer 161 and the conductive portion 162. As described above, the intermediate layer 16, the bottom metallic layer 15, and the top metallic layer 17 are included in the spacer layer 16s.

Oxide, nitride, oxynitride, and the like are used for the insulating layer 161. The insulating layer 161 may have an amorphous structure such as Al₂O₃ or a crystal structure such as MgO. To exhibit the function as the spacer layer, the insulating layer 161 has a thickness of preferably 1 nm to 5 nm, more preferably 1.5 nm to 4.5 nm.

As the insulating material used for the insulating layer 161, there are a material using Al₂O₃ as a base material and a material obtained by adding an additive element thereto. As the additive element, Ti, Hf, Mg, Zr, V, Mo, Si, Cr, Nb, Ta, W, B, C, V, and the like are given. The amount of the additive element may be appropriately changed within a range of about 0% to 50%. As an example, Al₂O₃ with a thickness of about 2 nm may be used as the insulating layer 161.

For the insulating layer 161, Ti oxide, Hf oxide, Mg oxide, Zr oxide, Cr oxide, Ta oxide, Nb oxide, Mo oxide, Si oxide, V oxide, and the like may be used in place of Al oxide such as Al₂O₃. Also in the case of these oxides, the materials described above may be used as the additive element. The amount of the additive element may be appropriately changed within a range of about 0% to 50%. Furthermore, for the insulating layer 161, for example, oxynitride or nitride on a base of Al, Si, Hf, Ti, Mg, Zr, V, Mo, Nb, Ta, W, B, and/or C may be used. That is, any insulating material on a base of these materials may be used for the insulating layer 161.

As described above, the conductive portion 162 is a path that conducts a current in the direction perpendicular to the surface of the intermediate layer 16, and confines the current.

The material of the conductive portion 162 may be metal Au, Ag, Al, Ni, Co, and Fe or an alloy containing at least one of these elements, as well as Cu. As an example, the conductive portion 162 may be formed of an alloy layer containing Cu. For the conductive portion 162, for example, an alloy layer of CuNi, CuCo, CuFe, and the like may be used. An alloy containing 50% or more Cu is preferably used as the conductive portion 162 in order to increase the MR ratio and decrease the interlayer coupling field (Hin) between the pinned layer 14 and the free layer 18.

The conductive portion 162 is a region in which the content of at least one of oxygen and nitrogen is very low as compared to the insulating layer 161. For example, the content of at least one of oxygen and nitrogen in the insulating layer 161 is twice or more that of the conductive portion 162. The conductive portion 162 may be a crystal phase, for example. The crystal phase has a lower resistance than an amorphous phase. Therefore, in the case where the conductive portion 162 is a crystal phase, the conductive portion 162 functions as a current path easily.

The top metallic layer 17 is included in the spacer layer 16s; and has the function as a barrier layer that protects the free layer 18 film-formed on the spacer layer 16s to prevent the free layer 18 from being in contact with the oxide of the intermediate layer 16 to be oxidized, and the function of providing the free layer 18 with a good crystallinity. For example, in the case where the insulating layer 161 is made of an amorphous material (e.g. Al₂O₃), the crystallinity of a metallic layer film-formed thereon deteriorates. However, a layer (e.g. Cu layer) that provides a good fcc crystallinity may be disposed on the insulating layer 161 as the top metallic layer 17, and thereby the crystallinity of the free layer 18 can be significantly improved. The top metallic layer 17 may have a thickness of about one nanometer or less.

The top metallic layer 17 need not necessarily be provided depending on the material of the intermediate layer 16 and/or the free layer 18. A decrease in crystallinity can be prevented by optimizing anneal conditions, appropriately selecting the material of the insulating layer 161 of the intermediate layer 16 and the material of the free layer 18, and the like, and this allows to omit the top metallic layer 17 on the intermediate layer 16.

In view of the manufacturing margin, the top metallic layer 17 is preferably formed on the intermediate layer 16. As an example, Cu with a thickness of 0.5 nm may be used as the top metallic layer 17.

For the top metallic layer 17, Au, Ag, Ru, and the like may be used as well as Cu. The top metallic layer 17 is preferably made of the same material as the material of the conductive portion 162 of the intermediate layer 16. In the case where the top metallic layer 17 is made of a material different from the material of the conductive portion 162, the interface resistance may be increased. In contrast, using the same material for both can suppress the increase in interface resistance.

The top metallic layer 17 has a film thickness of preferably 1 nm or less, more preferably 0.1 nm to 0.5 nm. An excessively large thickness of the top metallic layer 17 may cause the current confined by the intermediate layer 16 to spread in the top metallic layer 17 to result in an insufficient current-confined-path effect, which may decrease the MR ratio.

The free layer 18 is a layer containing a ferromagnetic of which the magnetization direction changes by an external magnetic field. A structure in which CoFe is interposed at the interface of NiFe, for example, may be used for the free layer 18. Specifically, a two-layer stack film of (CO₉₀Fe₁₀ with a thickness of 1 nm)/(Ni₈₃Fe₁₇ with a thickness of 13.5 nm) may be used. To obtain a high MR ratio, the selection of the magnetic material located in a portion of the free layer 18 on the side of the interface with the intermediate layer 16 is important. A CoFe alloy is more preferably provided than a NiFe alloy on the side of the interface with the intermediate layer 16. In the case where a NiFe layer is not used for the free layer 18, a CO₉₀Fe₁₀ single layer with a thickness of 4 nm may be used. Furthermore, a three-layer stack film such as CoFe/NiFe/CoFe may be used as the free layer 18.

In the case where a CoFe alloy is used as the free layer 18, for example, Co₉₀Fe₁₀ is preferable because the soft magnetic properties thereof are stable. In the case where a CoFe alloy with a composition close to that of CO₉₀Fe₁₀ is used, the film thickness is preferably 0.5 nm to 4 nm. Other than them, COₓFe₁₀₀₋ₓ (x=70 to 90) is preferable.

Furthermore, the free layer 18 may be formed of a stack film in which a CoFe layer or an Fe layer with a thickness of 1 nm to 2 nm and an extremely thin Cu layer with a thickness of about 0.1 nm to 0.8 nm are alternately stacked in plural.

In the case where the intermediate layer 16 is formed by using a Cu layer, also in the free layer 18, similarly to the pinned layer 14, an FeCo layer with the bcc crystal structure may be used as the material of a portion of the free layer 18 on the side of the interface with the intermediate layer 16. Thereby, the MR ratio increases. Also an FeCo alloy with the bcc structure may be used as the material of the portion of the free layer 18 on the side of the interface with the intermediate layer 16, in place of the CoFe alloy of fcc. In this case, FeₓCO₁₀₀₋ₓ (x=30 to 100) or a material obtained by adding an additive element thereto which easily forms the bcc structure may be used. To stabilize the bcc structure more, the film thickness is preferably 1 nm or more, more preferably 1.5 nm or more. However, as the film thickness of a layer with the bcc structure increases, the coercive force and the magnetic strain increase, and therefore the film becomes difficult to use as the free layer. To solve this, it is effective to adjust the composition and/or the film thickness of the NiFe alloy to be stacked. For example, a stack configuration of (CO₆₀Fe₄₀ with a thickness of 2 nm)/(Ni₉₅Fe₅ with a thickness of 3.5 nm) may be used as the free layer 18.

The cap layer 19 has the function of protecting the spin valve film. A stack film of a plurality of metallic layers, for example, may be used for the cap layer 19. For example, a stack film of a Cu layer and a Ru layer ((Cu with a thickness of 1 nm)/(Ru with a thickness of 10 nm)) may be used. Furthermore, also a Ru/Cu layer in which Ru is disposed on the free layer 18 side and the like may be used as the cap layer 19. In this case, the Ru layer preferably has a film thickness of about 0.5 nm to 2 nm. The cap layer 19 with this configuration is preferably used particularly in the case where NiFe is used as the free layer 18. Since Ru is not solid-soluble with Ni, using the configuration mentioned above enables to reduce the magnetic strain of an interface mixing layer formed between the free layer 18 and the cap layer 19.

In both the case where the cap layer 19 is Cu/Ru and the case where it is Ru/Cu, the Cu layer preferably has a film thickness of about 0.5 nm to 10 nm, and the Ru layer may have a film thickness of about 0.5 nm to 5 nm. Since Ru has a high specific resistance value, it is not preferable to use a Ru layer having a very large thickness. Therefore, a film thickness range like this is preferably used.

As the cap layer 19, another metallic layer may be provided in place of the Cu layer or the Ru layer. The configuration of the cap layer 19 is not limited in particular but any other material may be used that can protect the spin valve film as a cap. The cap layer is appropriately selected in view of the MR ratio and long-term reliability. Cu and Ru are desirable examples of the material of the cap layer also from these points of view.

The top electrode 20 is an electrode for conducting a current in the direction perpendicular to the spin valve film. By applying a voltage between the bottom electrode 11 and the top electrode 20, a current flows through the spin valve film in the direction perpendicular to the spin valve film. An electrically low resistive material (e.g. Cu, Au, NiFe, etc.) is used for the top electrode 20.

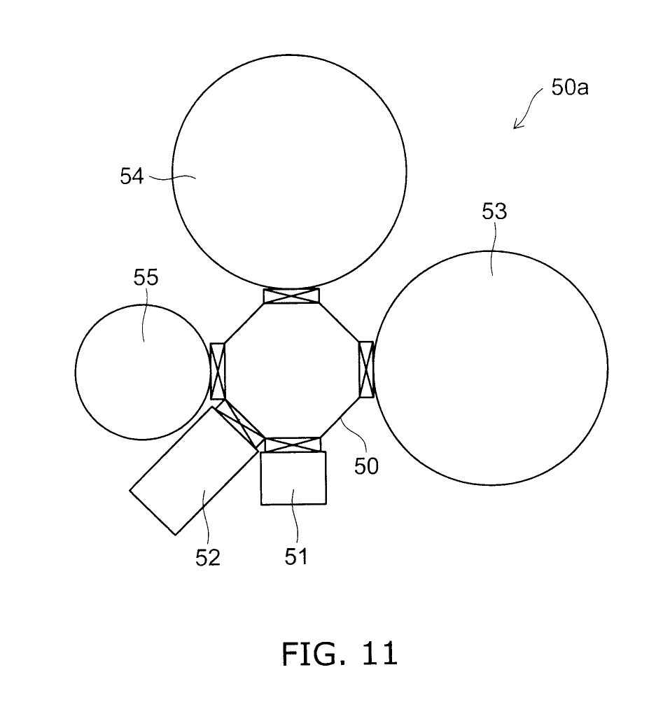

FIG. 11 is a schematic view illustrating the configuration of a manufacturing apparatus that may be used for the method for manufacturing a magneto-resistance effect element according to the first embodiment.

As illustrated in FIG. 11, in a manufacturing apparatus 50a that may be used for the method for manufacturing a magneto-resistance effect element according to the embodiment, a first chamber (load lock chamber) 51, a second chamber 52, a third chamber 53, a forth chamber 54, and a fifth chamber 55 are provided around a transfer chamber 50 each via a gate valve. The manufacturing apparatus 50a performs film-formation and various processings. Since a substrate can be transferred in vacuum between chambers each connected via a gate valve, the surface of the substrate can be kept clean.

The second chamber 52 is, for example, a chamber for pre-cleaning.

The third chamber 53 and the fourth chamber 54 are, for example, chambers for metal film-formation, and may include a plurality of targets (e.g. five to ten targets). As the film-formation method of the third chamber 53 and the fourth chamber 54, for example, a sputtering method such as DC magnetron sputtering and RF magnetron sputtering, the ion beam sputtering method, the vapor deposition method, the CVD (chemical vapor deposition) method, the MBE (molecular beam epitaxy) method, and the like are given.

In the fifth chamber 55, for example, an oxide layer, a nitride layer, and an oxynitride layer are formed.

A chamber having an RF plasma mechanism, an ion beam mechanism, or a heating mechanism may be used for the first treatment (AIT) and the second treatment (e.g. AO). Specifically, the third chamber 53, the fourth chamber 54, and the second chamber 52 having an RF bias mechanism and the like may be used. The RF plasma mechanism is a relatively simple mechanism, and is easily installed in the third chamber 53 and the fourth chamber 54. In the third chamber 53 and the fourth chamber 54, film-formation of a metallic film, ion beam treatment such as the AIT and the AO, and the like can be performed.

When the AIT and the AO are performed in the fifth chamber 55 in which oxide and/or nitride are formed, for example, in the AIT or the AO, oxygen gas (or nitrogen gas), for example, attached to the inner wall of the chamber may detach to get mixed in the structure body 16p and the like to degrade the structure body 16p and the like. In a chamber in which neither oxygen nor nitrogen is used in film-formation, such as the third chamber 53 and the fourth chamber 54, the attachment of oxygen and nitrogen to the inner wall of the chamber is limited and the quality of vacuum is easily retained. However, it is also possible to perform the AIT and the AO in the fifth chamber 55 when oxygen and nitrogen attached to the interior of the chamber are removed.

The degree of vacuum of the vacuum chamber mentioned above is, for example, at the 10⁻⁹ Torr level, and values in the lower half of the 10⁻⁸ Torr range are allowable.

An example of the outline of the entire method for manufacturing the magneto-resistance effect element 101 will now be described.

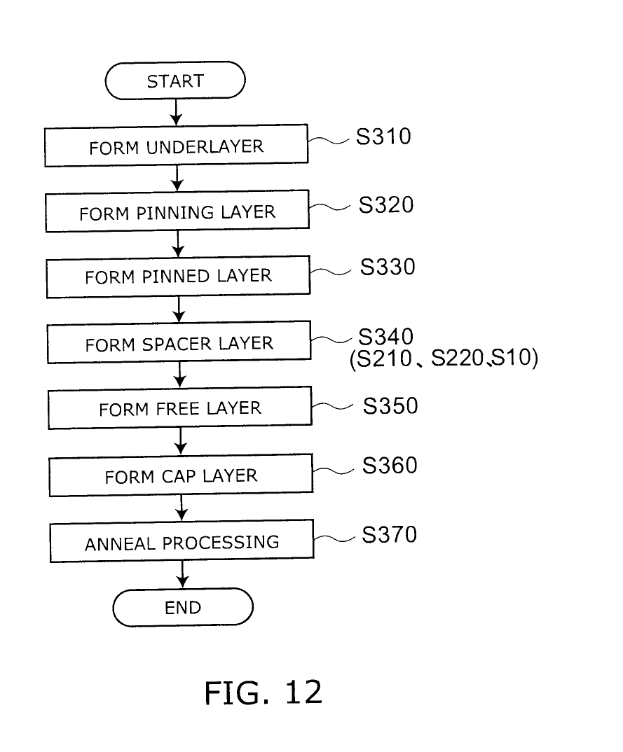

FIG. 12 is a flow chart illustrating the method for manufacturing a magneto-resistance effect element according to the first embodiment.

As illustrated in FIG. 12, the underlayer 12 is formed on the bottom electrode 11 formed on a not-illustrated substrate (step S310), the pinning layer 13 is formed thereon (step S320), and the pinned layer 14 is formed thereon (step S330). Then, the spacer layer 16s is formed (step S340). In the formation of the spacer layer 16s, the intermediate layer formation process (step S10), the process that forms the first nonmagnetic layer (step S210), and the process that forms the second nonmagnetic layer (step S220) described above are performed.

Further, after that, the free layer 18 is formed (step S350), the cap layer 19 is formed (step S360), the top electrode 20 is formed, and finally anneal processing is performed (step S370).

For example, a substrate is set in the first chamber 51 (load lock chamber), then the film-formation of various metallic films is performed in the third chamber 53 and the fourth chamber 54, and oxidation, for example, is performed in the fifth chamber 55. The ultimate pressure in the third chamber 53 and the fourth chamber 54 is preferably, for example, 1×10⁻⁸ Torr or less, generally about 5×10⁻¹⁰ Torr to 5×10⁻⁹ Torr. The ultimate pressure in the transfer chamber 50 is about 1×10⁻⁹ Torr to 1×10⁻⁸ Torr. The ultimate pressure in the fifth chamber 55 is 8×10⁻⁸ Torr or less.

For example, first, the bottom electrode 11 is formed on the substrate by a microfabrication process. A substrate with the bottom electrode 11 formed therein may be used. Then, Ta [5 nm]/Ru [2 nm], for example, is film-formed on the bottom electrode 11 as the underlayer 12.

Then, the pinning layer 13 is film-formed on the underlayer 12.

For the pinning layer 13, an antiferromagnetic material such as PtMn, PdPtMn, IrMn, RuRhMn, NiMn, and FeMn may be used. Also a hard magnetic material such as CoPt and CoPd may be used for the pinning layer 13.

Further, the pinned layer 14 is formed on the pinning layer 13.

The pinned layer 14 may be, for example, a synthetic pinned layer including the bottom pinned layer 141 (e.g. CO₉₀Fe₁₀), the antiparallel magnetic coupling layer 142 (e.g. Ru), and the top pinned layer 143 (e.g. CO₉₀Fe_{10 [}4 nm]). In the case where the pinning layer 13 is IrMn, using Fe₇₅CO₂₅ for the bottom pinned layer 141 can increase the pinning force by IrMn to improve magnetic stability. Furthermore, if the top pinned layer 143 is formed of a configuration in which extremely thin Cu is interposed in Fe₅₀Co₅₀ (e.g. Fe₅₀CO_{50 [}1 nm]/Cu [0.25 nm]/Fe₅₀CO_{50 [}1 nm]/Cu [0.25 nm]/Fe₅₀CO_{50 [}1 nm]) and the like, the spin dependent scattering increases and a high MR ratio can be obtained.

Next, the spacer layer 16s including the intermediate layer 16 is formed. The fifth chamber 55 is used in forming the intermediate layer 16. The processes illustrated in FIG. 6A and FIG. 6B are used in the formation of the spacer layer 16s. In this specific example, the intermediate layer 16 is formed in which the conductive portion 162 containing Cu with a metallic crystal structure is provided in the insulating layer 161 containing Al₂O₃ with an amorphous structure. Herein, the case is described where the process of FIG. 6A is used.

Cu [0.25 nm], for example, is film-formed on the intermediate layer 16 as the top metallic layer 17. The top metallic layer 17 preferably has a film thickness of about 0.2 nm to 0.6 nm. A large film thickness of the top metallic layer 17 facilitates increasing the crystallinity of the free layer 18. However, an excessively large film thickness may reduce the current-confined-path effect to decrease the MR ratio. Accordingly, to achieve both increasing the crystallinity of the free layer 18 and retaining the MR ratio, the top metallic layer 17 preferably has a film thickness of about 0.4 nm.

In the case where a high crystallinity is not necessary in the free layer 18, or in the case where the crystallinity of the free layer 18 can be increased by some other means, the top metallic layer 17 is not necessarily needed but may be omitted.

On the top metallic layer 17, for example, CO₉₀Fe_{10 [}1 nm]/Ni₈₃Fe_{17 [}3.5 nm] is formed as the free layer 18. To obtain a high MR ratio, the magnetic material of the free layer 18 located at the interface with the spacer layer 16s is appropriately selected. In this specific example, the CoFe alloy is more preferably provided than the NiFe alloy in a portion of the free layer 18 on the side of the interface with the spacer layer 16s. Among the CoFe alloys, particularly CO₉₀Fe_{10 [}1 nm] with stable soft magnetic properties may be used for the portion on the interface side. Furthermore, a CoFe alloy with another composition may be used.

In the case where a CoFe alloy with a composition close to Co₉₀Fe₁₀ is used for the portion of the free layer 18 on the side of the interface with the spacer layer 16s, the film thickness is preferably 0.5 nm to 4 nm. In the case where a CoFe alloy with another composition (e.g. CO₅₀Fe₅₀) is used, the film thickness is preferably 0.5 nm to 2 nm. In the case where Fe₅₀CO₅₀ (or FeₓCO₁₀₀₋ₓ (x=45 to 85)), for example, is used for the portion of the free layer 18 on the side of the interface with the spacer layer 16s in order to enhance the spin dependent interface scattering effect, it is difficult to set the film thickness of the portion of the free layer 18 on the side of the interface with the spacer layer 16s thick like the pinned layer 14, because of the requirement of retaining the soft magnetic properties as the free layer 18. Therefore, in this case, the portion of the free layer 18 on the side of the interface with the spacer layer 16s preferably has a film thickness of 0.5 nm to 1 nm. In the case where Fe containing no Co is used as the portion of the free layer 18 on the side of the interface with the spacer layer 16s, since the soft magnetic properties are relatively good, the film thickness is allowed to be about 0.5 nm to 4 nm.

In the configuration mentioned above of the free layer 18, the NiFe layer provided on the CoFe layer is a material having stable soft magnetic properties. Although the soft magnetic properties of the CoFe alloy are not stable so much, the soft magnetic properties can be stabilized by providing the NiFe alloy on the CoFe alloy. NiFe is preferably used as the free layer 18 from the viewpoint of the total characteristics of the spin valve film, because a material capable of achieving a high MR ratio can be used for the portion on the side of the interface with the spacer layer 16s.

The NiFe alloy used for the free layer 18 preferably has a composition of NiₓFe₁₀₀₋ₓ (x=about 78 to 85). That is, a composition (e.g. Ni₈₃Fe₁₇) containing more Ni than Ni₈₁Fe₁₉ which is a commonly used composition of NiFe is preferably used. Thereby, zero magnetic strain can be achieved. In the NiFe film-formed on the spacer layer 16s that includes the intermediate layer 16 including the insulating layer 161 and the conductive portion 162, the magnetic strain shifts to the plus side more than in NiFe film-formed on a spacer layer of metal Cu. To cancel the shift of the magnetic strain to the plus side, a NiFe composition on the negative side in which Ni content is larger than usual is used for the NiFe used for the free layer 18.

The total film thickness of the NiFe layer used for the free layer 18 is preferably about 2 nm to 5 nm (e.g. 3.5 nm).

In the case where a NiFe layer is not used as the free layer 18, the free layer 18 may be formed of a stack film in which a CoFe layer or an Fe layer with a thickness of 1 nm to 2 nm and a Cu layer with a thickness of about 0.1 nm to 0.8 nm are alternately stacked in plural.

Then, on the free layer 18, Cu [1 nm]/Ru [10 nm], for example, is stacked as the cap layer 19. Then, the top electrode 20 for conducting a current vertically to the spin valve film is formed on the cap layer 19.

Thus, the magneto-resistance effect element 101 according to the first embodiment illustrated in FIG. 1 can be manufactured.

### Second Embodiment

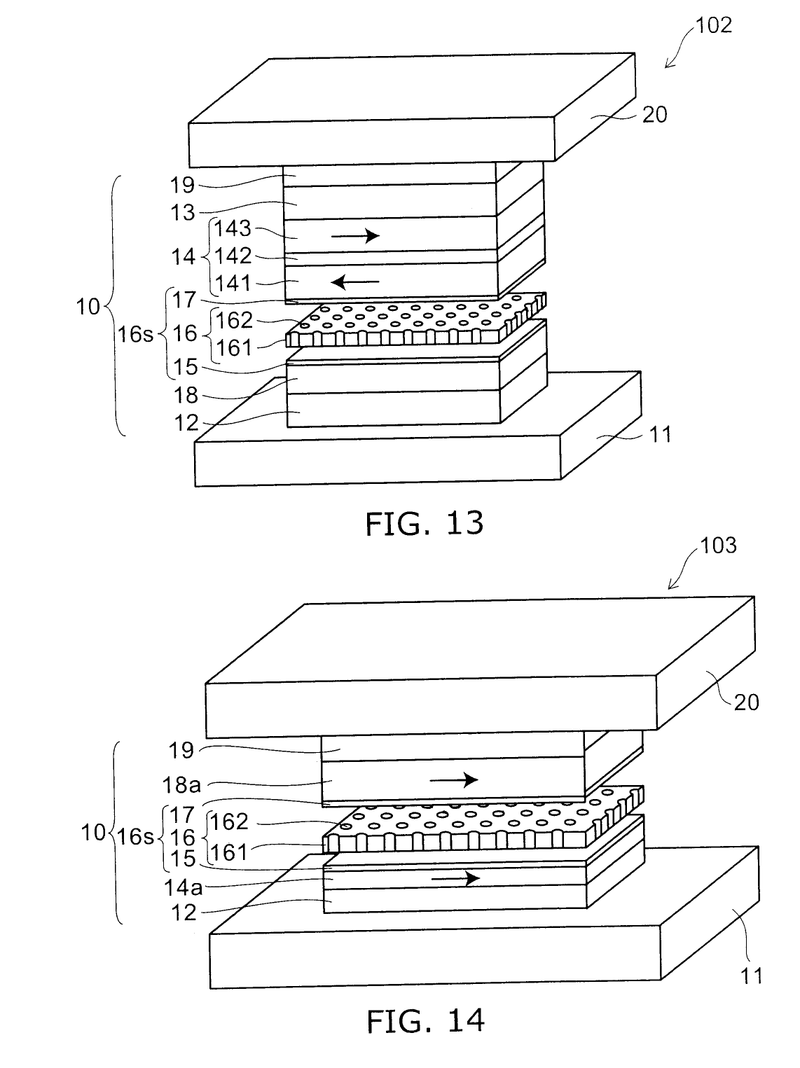

FIG. 13 is a schematic perspective view illustrating the configuration of a magneto-resistance effect element to which a method for manufacturing a magneto-resistance effect element according to a second embodiment is applied.

As illustrated in FIG. 13, a magneto-resistance effect element 102 according to this embodiment is a top-pinned CCP-CPP element in which the pinned layer 14 is disposed above the free layer 18.

Also in this case, the magneto-resistance effect element 102 includes: the first magnetic layer (in this specific example, the pinned layer 14) containing a ferromagnetic; the second magnetic layer (in this specific example, the free layer 18) containing a ferromagnetic; and the intermediate layer 16 provided between the first magnetic layer and the second magnetic layer. The intermediate layer 16 includes the insulating layer 161 and the conductive portion 162 penetrating through the insulating layer 161.

Also in this specific example, the magnetization direction of one of the first magnetic layer and the second magnetic layer is substantially fixed, and the magnetization direction of the other of the first magnetic layer and the second magnetic layer changes in accordance with an external magnetic field applied to the other of the first magnetic layer and the second magnetic layer. That is, the first magnetic layer is the pinned layer 14 of which the magnetization direction is substantially fixed, and the second magnetic layer is the free layer 18 of which the magnetization direction changes in accordance with an external magnetic field applied thereto.

Further, in this case, the first nonmagnetic layer provided between the first magnetic layer (in this specific example, the pinned layer 14) and the intermediate layer 16 forms the top metallic layer 17, and the second nonmagnetic layer provided between the second magnetic layer (in this specific example, the free layer 18) and the intermediate layer 16 forms the bottom metallic layer 15.

Specifically, in the magneto-resistance effect film 10, for example, the underlayer 12, the free layer 18, the bottom metallic layer 15, the intermediate layer 16 (the insulating layer 161 and the conductive portion 162), the top metallic layer 17, the pinned layer 14, the pinning layer (antiferromagnetic layer) 13, and the cap layer 19 are stacked in this order on the bottom electrode 11, and the top electrode 20 is stacked on the magneto-resistance effect film 10.

Also in the manufacture of the magneto-resistance effect element 104 with such a configuration, the intermediate layer formation process (step S10) that forms the intermediate layer 16 may include the structure body formation process (step S110), the first treatment process (step S120), and the second treatment process (step S130) mentioned above.

Also in the case of the top-pinned spin valve film, the effects of preventing excessive oxidation of the pinned layer 14 and recovering the insulating layer 161 from damage due to the first treatment (AIT) are obtained similarly to the bottom-pinned type.

As in the case of the bottom-pinned type, also in the top-pinned magneto-resistance effect element 102, treatment with ion, plasma, oxygen exposure, or heat may be appropriately used as the first treatment and the second treatment.

Also in the top-pinned magneto-resistance effect element 102, the bottom metallic layer 15 and the top metallic layer 17 of the intermediate layer 16 have functions similar to those of the bottom-pinned magneto-resistance effect element 101. That is, whereas the bottom metallic layer 15 on the lower side of the intermediate layer 16 serves as a source of the conductive portion 162, the top metallic layer 17 on the intermediate layer 16 is not necessarily needed, and is provided as necessary.

### Third Embodiment

FIG. 14 is a schematic perspective view illustrating the configuration of a magneto-resistance effect element to which a method for manufacturing a magneto-resistance effect element according to a third embodiment is applied.

As illustrated in FIG. 14, in a magneto-resistance effect element 103 according to this embodiment, the intermediate layer 16 is provided between two free layers (a first free layer 14a and a second free layer 18a).

That is, the magneto-resistance effect element 103 includes: the first magnetic layer (in this specific example, the first free layer 14a) containing a ferromagnetic; the second magnetic layer (in this specific example, the second free layer 18a) containing a ferromagnetic; and the intermediate layer 16 provided between the first magnetic layer and the second magnetic layer. The intermediate layer 16 includes the insulating layer 161 and the conductive portion 162 penetrating through the insulating layer 161.

The magnetization direction of the first magnetic layer (the first free layer 14a) changes in accordance with an external magnetic field applied to the first magnetic layer, and the magnetization direction of the second magnetic layer (the second free layer 18a) changes in accordance with an external magnetic field applied to the second magnetic layer.

An angle between a magnetization direction of the first magnetic layer (the first free layer 14a) and a magnetization direction of the second magnetic layer (the second free layer 18a) changes in accordance with an external magnetic field applied to the first magnetic layer (the first free layer 14a) and the second magnetic layer (the second free layer 18a).

Specifically, the magneto-resistance effect film 10 is provided on the bottom electrode 11 provided on a not-illustrated substrate, and the top electrode 20 is provided on the magneto-resistance effect film 10. Furthermore, in the magneto-resistance effect film 10, for example, the underlayer 12, the first free layer 14a, the bottom metallic layer 15, the intermediate layer 16 (the insulating layer 161 and the conductive portion 162), the top metallic layer 17, the second free layer 18a, and the cap layer (protective layer) 19 are stacked in this order.

Thus, the spin valve film of the magneto-resistance effect element 103 has a configuration in which the nonmagnetic spacer layer 16s (including the bottom metallic layer 15, the intermediate layer 16, and the top metallic layer 17) is placed between the two ferromagnetic layers (the first free layer 14a and the second free layer 18a).

In the magneto-resistance effect film 10 of this specific example, the magnetization directions of both of the two ferromagnetic layers (the first free layer 14a and the second free layer 18a) are rotatable in accordance with an external magnetic field. That is, the magnetization fixed layer is not provided in the magneto-resistance effect element 103.

Also the magneto-resistance effect element 103 with such a configuration can increase the MR ratio by performing the first treatment (AIT) and the second treatment (e.g. AO) in combination after the structure body formation process, as described above.

Also in this case, as described in regard to FIGS. 6A and 6B, the first treatment and the second treatment may be performed either after or before the formation of the top metallic layer 17.

### Fourth Embodiment

A magneto-resistance effect element according to a fourth embodiment is one of the magneto-resistance effect elements 101, 101a, 102, and 103 manufactured by the methods for manufacturing a magneto-resistance effect element described in regard to the first to third embodiments. Hereinbelow, the case is described where the magneto-resistance effect element according to the fourth embodiment is the magneto-resistance effect element 101.

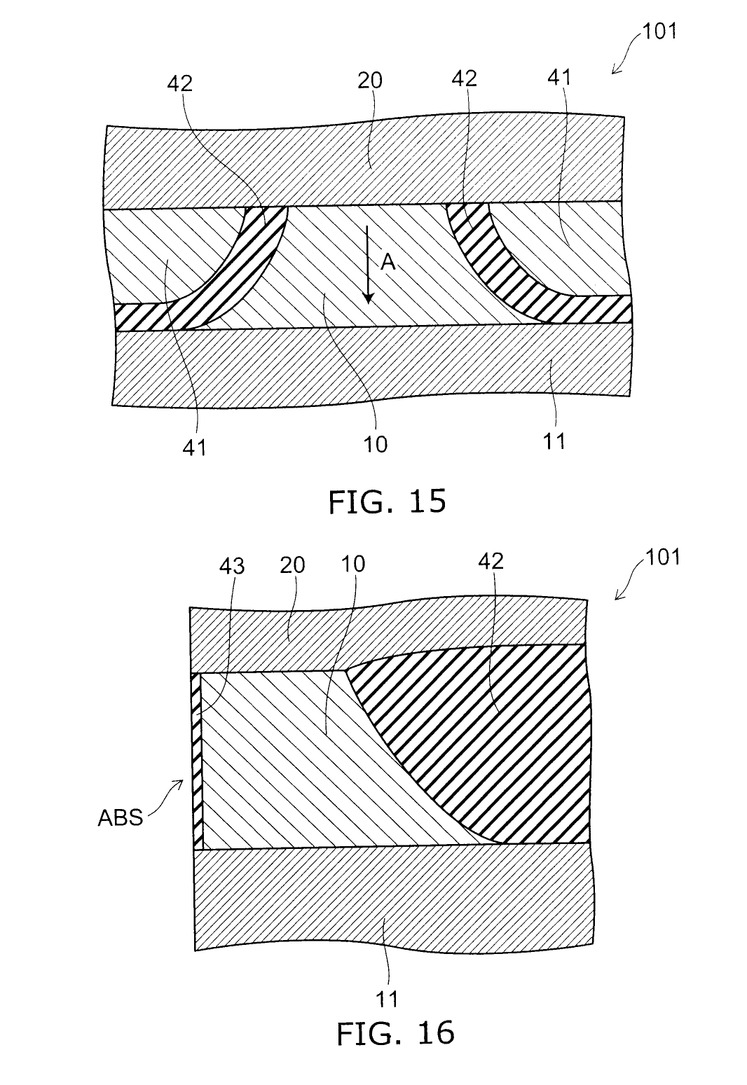

FIG. 15 and FIG. 16 are schematic cross-sectional views illustrating the configuration of the magneto-resistance effect element according to the fourth embodiment.

That is, these drawings illustrate a state in which the magneto-resistance effect element 101 according to this embodiment is installed in a magnetic head. FIG. 15 is a cross-sectional view when the magneto-resistance effect element 101 is cut in a direction nearly parallel to a medium-facing surface opposed to a magnetic recording medium (not illustrated), and FIG. 16 is a cross-sectional view when the magneto-resistance effect element 101 is cut in the direction perpendicular to the medium-facing surface ABS.

The magnetic head illustrated in FIG. 15 and FIG. 16 has what is called a hard abutted structure.

As illustrated in FIG. 15 and FIG. 16, the bottom electrode 11 and the top electrode 20 are provided below and on the magneto-resistance effect film 10 of the magneto-resistance effect element 101, respectively. A bias magnetic field application film 41 and an insulating film 42 are provided in a stack configuration on both side faces of the magneto-resistance effect film 10. Furthermore, a protective layer 43 is provided on the medium-facing surface ABS side of the magneto-resistance effect film 10.

A sense current to the magneto-resistance effect film 10 is passed in a direction nearly perpendicular to the surface of the film by the bottom electrode 11 and the top electrode 20 disposed therebelow and thereon, as indicated by an arrow “A”. Furthermore, a bias magnetic field is applied to the magneto-resistance effect film 10 by a pair of bias magnetic field application films 41 provided left and right. The bias magnetic field controls the magnetic anisotropy of the free layer 18 of the magneto-resistance effect film 10 to make a single magnetic domain. Thereby, the magnetic domain structure is stabilized, and the Barkhausen noise accompanying the movement of magnetic domain walls can be suppressed. Since the S/N ratio of the magneto-resistance effect film 10 is increased, high-sensitive magnetic recording and reproducing can be performed when the element is used for a magnetic head.

The magneto-resistance effect element according to the embodiment preferably has an element resistance R^{A} of 500 mΩ·μm² or less, more preferably 300 mΩ·μm² or less in view of adaptation to high density. The element resistance RA is calculated by multiplying the resistance R of the magneto-resistance effect element by the effective area A of the current-carrying portion of the spin valve film. The resistance R can be directly measured. On the other hand, the effective area A of the current-carrying portion of the spin valve film is a value dependent on the element structure, and therefore the determination thereof requires attention.

For example, in the case where patterning is performed so that the whole of the spin valve film may be a region that performs sensing effectively, the area of the entire spin valve film is the effective area A. In this case, in view of setting the resistance R to a proper value, the area of the spin valve film is set at least not more than 0.04 μm², and in the case of a recording density of 300 Gbpsi or more, not more than 0.02 μm².

On the other hand, in the case where the bottom electrode 11 or the top electrode 20 with a smaller area than the spin valve film is formed, the area of the bottom electrode 11 or the top electrode 20 is the effective area A of the spin valve film. In the case where the areas of the bottom electrode 11 and the top electrode 20 are different, the area of the smaller electrode is the effective area A of the spin valve film. In this case, in view of setting the resistance R to a proper value, the area of the smaller electrode is set at least not more than 0.04 μm².

In FIG. 15, the region where the area of the magneto-resistance effect film 10 of the magneto-resistance effect element 101 is smallest is the portion in contact with the top electrode 20. Therefore, the width of the portion is assumed to be the track width Tw. Furthermore, in regard to the height direction, the portion in contact with the top electrode 20 is still smallest in FIG. 16. Therefore, the width of the portion is assumed to be the height length Dh. The effective area A of the spin valve film is assumed to be A=Tw×Dh.

In the magneto-resistance effect element 101 according to the embodiment, the resistance R between the electrodes can be made 100Ω or less. The resistance R is, for example, a resistance value measured between two electrode pads of a reproducing head unit provided at the end of a head gimbal assembly (HGA, magnetic head assembly).

In the magneto-resistance effect element 101 according to the embodiment, in the case where the pinned layer 14 or the free layer 18 has the fcc structure, it preferably has the fcc (111) orientation. In the case where the pinned layer 14 or the free layer 18 has the bcc structure, it preferably has the bcc (110) orientation. In the case where the pinned layer 14 or the free layer 18 has the hcp structure, it preferably has the hcp (001) orientation or the hcp (110) orientation.

The crystal orientation of the magneto-resistance effect element 101 according to the embodiment is, in terms of the variation angle of orientation, preferably within 4.0 degrees, more preferably within 3.5 degrees, still more preferably within 3.0 degrees. This is found as a half width of the rocking curve at the peak position obtained through θ-2θ measurement of X-ray diffraction. Furthermore, it can be detected as a dispersion angle of spot in nanodiffraction spots of a cross section of the element.

Generally, the lattice spacing is different between: an antiferromagnetic film; and the pinned layer 14, the spacer layer 16s, and the free layer 18, depending on the material of the antiferromagnetic film. Therefore, the variation angle of orientation can be calculated separately for each layer. For example, in many cases, the lattice spacing is different between: platinum manganese (PtMn); and the pinned layer 14, the spacer layer 16s, and the free layer 18. Since the platinum manganese (PtMn) is a relatively thick film, it is a material suitable for the measurement of the variation of crystal orientation. In regard to the pinned layer 14, the spacer layer 16s, and the free layer 18, the crystal structure may be different between the pinned layer 14 and the free layer 18, like the bcc structure and the fcc structure. In this case, the pinned layer 14 and the free layer 18 have different dispersion angles of crystal orientation.

### Fifth Embodiment

A fifth embodiment is a magnetic recording and reproducing apparatus. The magnetic recording and reproducing apparatus includes a magneto-resistance effect element manufactured by the manufacturing method according to the embodiment. That is, the magnetic recording and reproducing apparatus uses a magnetic head equipped with the magneto-resistance effect element manufactured by the manufacturing method according to the embodiment. Hereinbelow, the case is described where the magneto-resistance effect element 101 is mounted in the magnetic head.

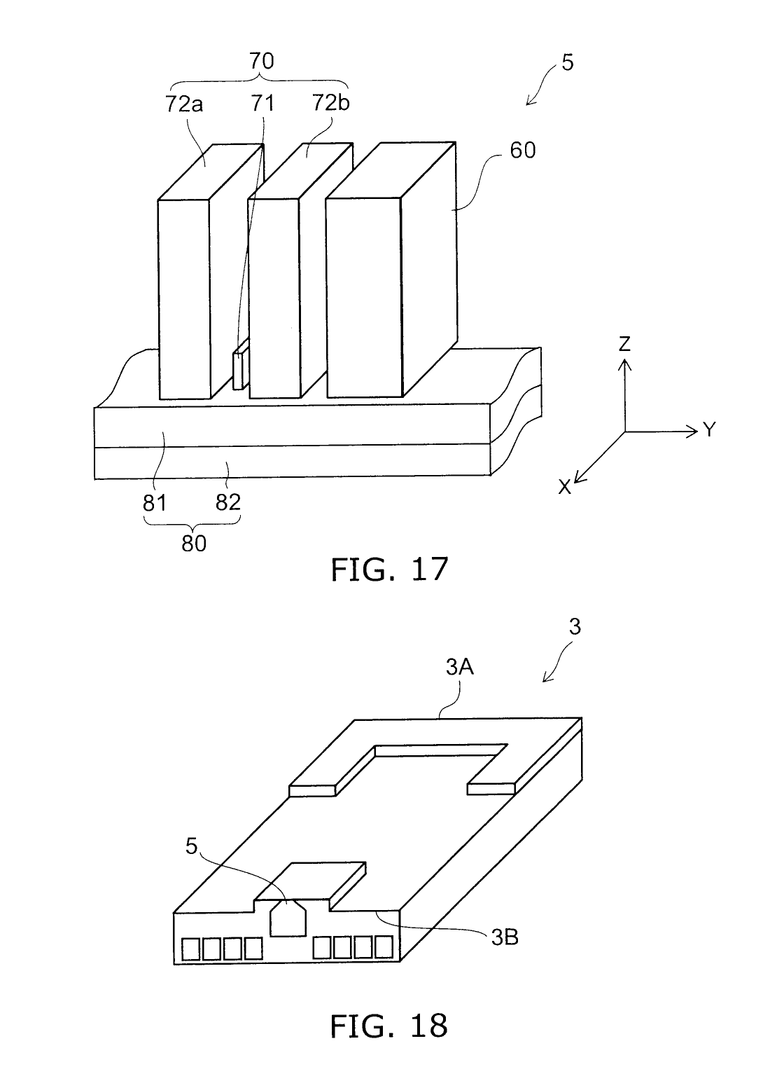

FIG. 17 is a schematic perspective view illustrating the configuration of part of the magnetic recording and reproducing apparatus according to the fifth embodiment.

That is, the drawing illustrates the configuration of the magnetic head equipped with the magneto-resistance effect element.

As illustrated in FIG. 17, a magnetic head 5 equipped with the magneto-resistance effect element 101 according to the embodiment is provided opposite to a magnetic recording medium 80. The magnetic recording medium 80 includes a magnetic recording layer 81 and a backing layer 82. The magnetic recording layer 81 is opposed to the magnetic head 5.

The magnetic head 5 includes: a writing head unit 60 opposed to the magnetic recording medium 80; and a reproducing head unit 70 juxtaposed to the writing head unit 60 and opposed to the magnetic recording medium 80.

However, it is sufficient that the magnetic head 5 includes the reproducing head unit 70, and the writing head unit 60 may be omitted and is provided as necessary. Hereinbelow, the case is described where the magnetic recording and reproducing apparatus according to the embodiment has a configuration in which the magnetic head 5 includes the writing head unit 60 and the magnetic recording and reproducing apparatus performs both the write operation and the reproduce operation. However, the writing head unit 60 may not be provided in the magnetic head 5, that is, the magnetic recording and reproducing apparatus may be a reproduce-only apparatus.

The reproducing head unit 70 includes: a first magnetic shield layer 72a; a second magnetic shield layer 72b; and a magnetic reproducing element 71 provided between the first magnetic shield layer 72a and the second magnetic shield layer 72b. The magneto-resistance effect element 101, for example, according to the embodiment is used as the magnetic reproducing element 71.

The magnetic reproducing element 71 reads the direction of magnetization of the magnetic recording layer 81 to read record information recorded in the magnetic recording medium 80.

The direction perpendicular to a face of the magnetic recording layer 81 opposed to the magnetic head 5 is taken as a Z-axis direction. One direction perpendicular to the Z-axis direction is taken as an X-axis direction. The direction perpendicular to the Z-axis direction and the X-axis direction is taken as a Y-axis direction. As described later, the magnetic recording medium 80 may have a disc shape, and the relative positions of the magnetic recording medium 80 and the magnetic head 5 are changed along the circumference of the magnetic recording medium 80. The X-Y-Z coordination system mentioned above may be defined within a short distance near the magnetic head 5.

The magnetic recording medium 80 moves relative to the magnetic head 5 along a direction perpendicular to the Z-axis direction, for example. The magnetic head 5 controls the magnetization of each position in the magnetic recording layer 81 of the magnetic recording medium 80 to perform magnetic recording. The direction of the movement of the magnetic recording medium 80 is, for example, the Y-axis direction. The relative movement of the magnetic recording medium 80 and the magnetic head 5 may be performed by the movement of the magnetic head 5. It is sufficient that the magnetic recording medium 80 and the magnetic head 5 move relatively along a direction perpendicular to the Z-axis direction.

The magnetic head 5 is mounted in the head slider 3 described later, and the magnetic head 5 is held distant from the magnetic recording medium 80 by the function of the head slider 3.

A not-illustrated magnetic shield may be provided around the magneto-resistance effect element 101 to prescribe the detection resolution of the magnetic head 5.

FIG. 18 is a schematic perspective view illustrating the configuration of part of the magnetic recording and reproducing apparatus according the fifth embodiment.

That is, the drawing illustrates the configuration of a head slider that is part of the magnetic recording and reproducing apparatus according to this embodiment.

As illustrated in FIG. 18, the magnetic head 5 is mounted in a head slider 3. The head slider 3 contains Al₂O₃, TiC, or the like, and is designed and fabricated so as to be capable of moving relatively while flying above or being in contact with the magnetic recording medium 80 such as a magnetic disk.

The head slider 3 includes, for example, an air inflow side 3A and an air outflow side 3B, and the magnetic head 5 is disposed at the side face of the air outflow side 3B or the like. Thereby, the magnetic head 5 mounted in the head slider 3 moves relatively while flying above or being in contact with the magnetic recording medium 80.

An example of the configuration of the whole magnetic recording and reproducing apparatus according to the embodiment will now be described by dealing with a magnetic recording and reproducing apparatus 250 as an example.

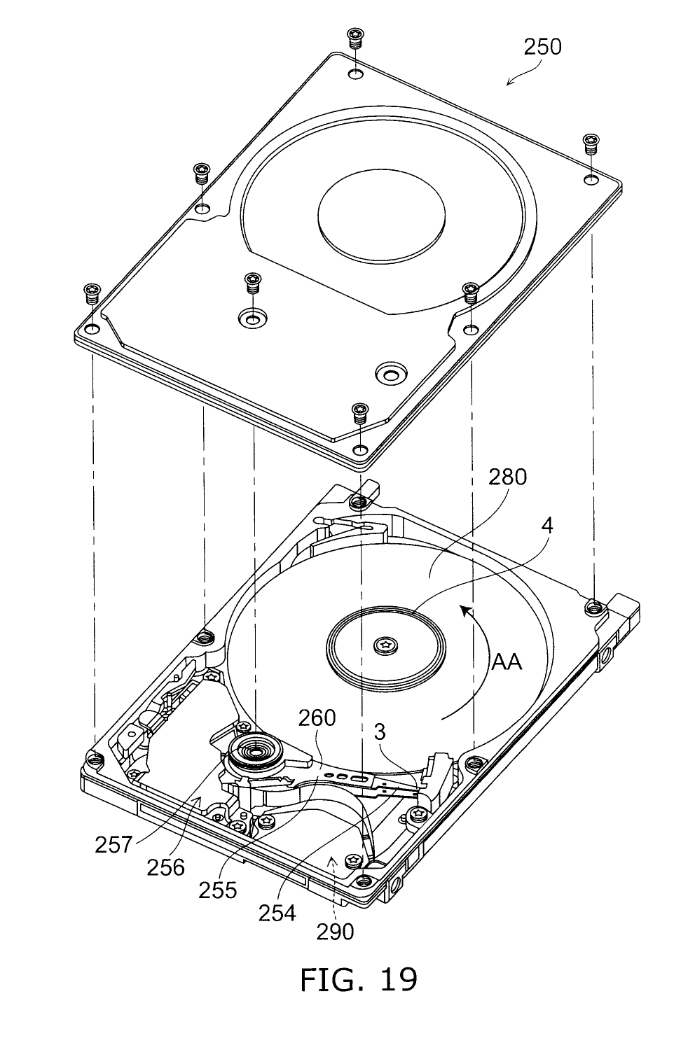

FIG. 19 is a schematic perspective view illustrating the configuration of a magnetic recording and reproducing apparatus according to the fifth embodiment.

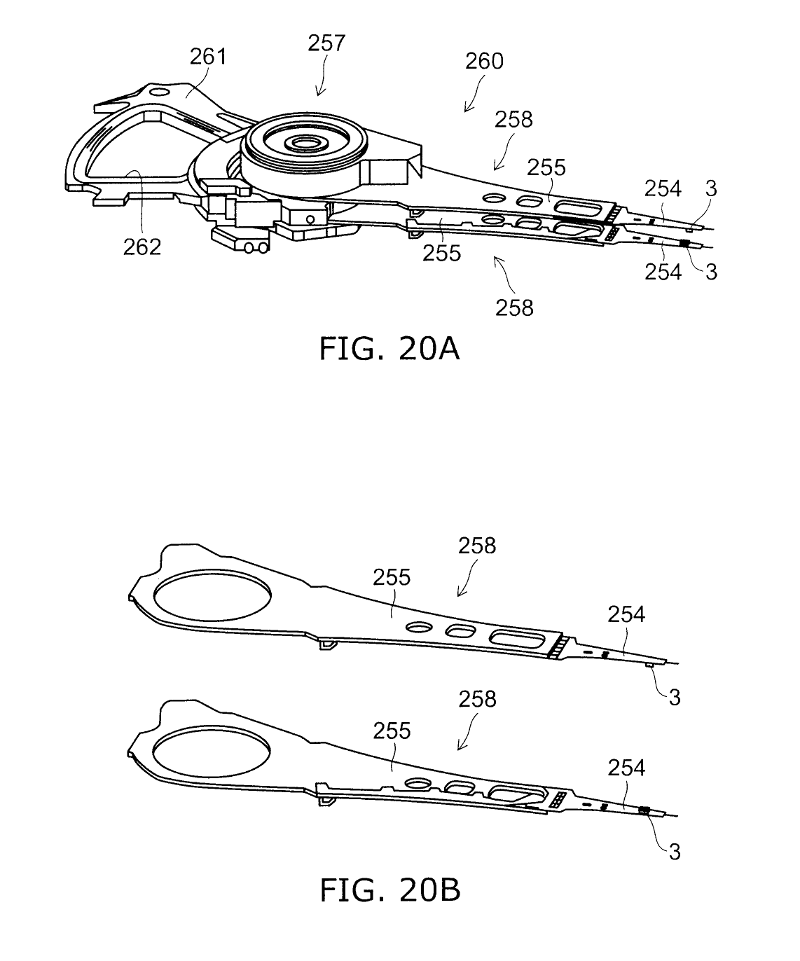

FIGS. 20A and 20B are schematic perspective views illustrating the configuration of part of the magnetic recording and reproducing apparatus according to the fifth embodiment.

That is, FIG. 20A illustrates an enlarged view of a head stack assembly 260 included in the magnetic recording and reproducing apparatus 250, and FIG. 20B illustrates a magnetic head assembly (head gimbal assembly) 258 which is part of the head stack assembly 260.

As illustrated in FIG. 19, the magnetic recording and reproducing apparatus 250 is an apparatus of a form using a rotary actuator. A recording medium disk 280 is set at a spindle motor 4, and rotates in the direction of an arrow AA with a not-illustrated motor that responds to a control signal from a not-illustrated driving device control unit. The magnetic recording and reproducing apparatus 250 may include a plurality of recording medium disks 280.

The head slider 3 that performs recording and reproducing of information stored in the recording medium disk 280 is provided at the end of a suspension 254 in a thin film form.

When the recording medium disk 280 rotates, the pressing pressure by the suspension 254 and the pressure generated at the medium-facing surface of the head slider 3 are in balance, and the medium-facing surface of the head slider 3 is held with a certain flying height from the surface of the recording medium disk 280. Also what is called a “contact running type” is possible in which the head slider 3 is in contact with the recording medium disk 280.

The suspension 254 is connected to one end of an actuator arm 255 including a bobbin unit that holds a not-illustrated driving coil and the like. A voice coil motor 256 which is a kind of linear motor is provided at the other end of the actuator arm 255. The voice coil motor 256 includes: a not-illustrated driving coil wound up at the bobbin portion of the actuator arm 255; and a magnetic circuit formed of a permanent magnet and an opposing yoke that are disposed opposite to each other so as to sandwich the driving coil.

The actuator arm 255 is held by not-illustrated two ball bearings provided in the upper and lower portions of a bearing unit 257, and can rotationally slide freely by means of the voice coil motor 256. Consequently, the magnetic head 5 can move to an arbitrary position on the recording medium disk 280.

As illustrated in FIG. 20A, the head stack assembly 260 includes: the bearing unit 257; the head gimbal assembly 258 extending from the bearing unit 257; and a supporting frame 261 extending from the bearing unit 257 in the opposite direction from the head gimbal assembly 258 and supporting a coil 262 of the voice coil motor.

Furthermore, as illustrated in FIG. 20B, the head gimbal assembly 258 includes: the actuator arm 255 extending from the bearing unit 257; and the suspension 254 extending from the actuator arm 255. The head slider 3 is provided at the end of the suspension 254.

This specific example deals with an example in which two head gimbal assemblies 258 are provided, but the number of head gimbal assemblies 258 may be one.

Thus, the magnetic head assembly (head gimbal assembly) 258 includes: the magnetic head 5; the head slider 3 equipped with the magnetic head 5; the suspension 254 equipped with the head slider 3 at one end thereof; and the actuator arm 255 connected to the other end of the suspension 254.

The suspension 254 includes a lead (not illustrated) for use in writing and reading of a signal, for use as a heater for flying height adjustment, and/or for other uses; and the lead and each electrode of the magnetic head 5 installed in the head slider 3 are electrically connected.

As illustrated in FIG. 19, a signal processing unit 290 is provided that uses the magnetic head 5 to perform writing and readout of a signal on/from the magnetic recording medium 80. The signal processing unit 290 is provided for example on the back side, in terms of the drawing, of the magnetic recording and reproducing apparatus 250 illustrated in FIG. 19. The input/output line of the signal processing unit 290 is connected to the electrode pad of the head gimbal assembly 258 and is electrically connected to the magnetic head.

Thus, the magnetic recording and reproducing apparatus 250 according to this embodiment may further include, in addition to the magnetic recording medium 80 and the magnetic head 5, a moving unit that moves relatively the magnetic recording medium 80 and the magnetic head 5 while keeping them opposite to each other in a state in which the magnetic recording medium 80 and the magnetic head 5 are separated from or placed in contact with each other, a positional control unit that aligns the magnetic head 5 with a prescribed recording position on the magnetic recording medium 80, and the signal processing unit 290 that uses the magnetic head 5 to perform writing and reading of a signal on/from the magnetic recording medium.

That is, the recording medium disk 280 is used as the magnetic recording medium 80 mentioned above. The moving unit mentioned above may include the head slider 3. The positional control unit mentioned above may include the head gimbal assembly 258.

### Sixth Embodiment

Next, a magnetic memory equipped with a magneto-resistance effect element according to the embodiment will now be described as a magnetic recording and reproducing apparatus according to a sixth embodiment. That is, by using the magneto-resistance effect element according to the embodiment, a magnetic memory such as a magnetic random access memory (MRAM) in which memory cells are disposed in a matrix form can be provided. Hereinbelow, the case is described where the magneto-resistance effect element 101 described in the first embodiment is used as the magneto-resistance effect element. However, one of the magneto-resistance effect elements 101, 101a, 102, and 103 according to embodiments may be used.

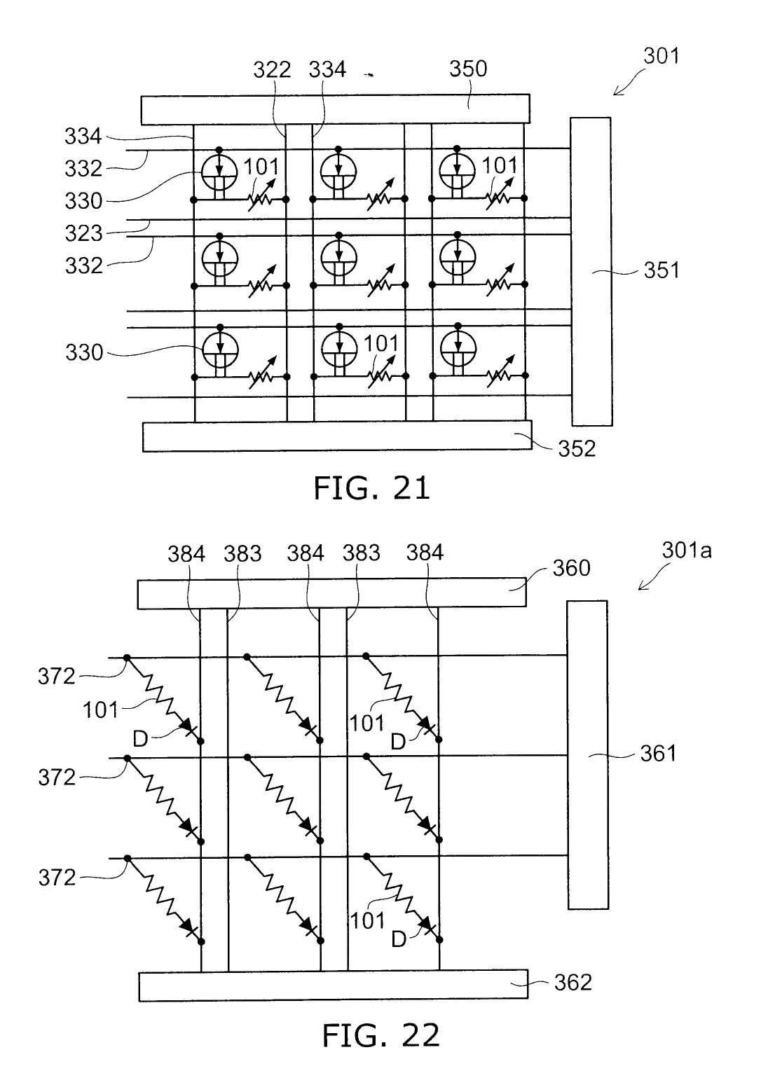

FIG. 21 is a schematic diagram illustrating the configuration of the magnetic recording and reproducing apparatus according to the sixth embodiment.

That is, the drawing illustrates the circuit configuration of a magnetic recording and reproducing apparatus 301 including memory cells disposed in an array form.

As illustrated in FIG. 21, in the magnetic recording and reproducing apparatus 301 according to this embodiment, a column decoder 350 and a row decoder 351 are provided in order to select one bit (one memory cell) in the array. A switching transistor 330 becomes ON through a bit line 334 connected to the column decoder 350 and a word line 332 connected to the row decoder 351, and the memory cell (the magneto-resistance effect element 101) is selected uniquely. Then, a sense amplifier 352 detects a current flowing through the magneto-resistance effect element 101 to read out bit information recorded in the magnetic recording layer (free layer) in the magneto-resistance effect film 10 included in the magneto-resistance effect element 101.

On the other hand, when writing information on each memory cell, a write current is passed through a specific write word line 323 and a specific bit line 322 to generate a magnetic field, and this magnetic field is applied to each memory cell.

FIG. 22 is a schematic diagram illustrating another configuration of the magnetic recording and reproducing apparatus according to the sixth embodiment.

As illustrated in FIG. 22, in another magnetic recording and reproducing apparatus 301a according to this embodiment, bit lines 372 and word lines 384 wired in a matrix form are each selected by decoders 360, 361, and 362 to select a specific memory cell in the array. Each memory cell has a configuration in which the magneto-resistance effect element 101 and a diode D are connected in series. Here, the diode D has the function of preventing a sense current from detouring in a memory cell other than the selected magneto-resistance effect element 101. The writing is performed by a magnetic field generated by passing a write current through a specific bit line 372 and a specific write word line 383.

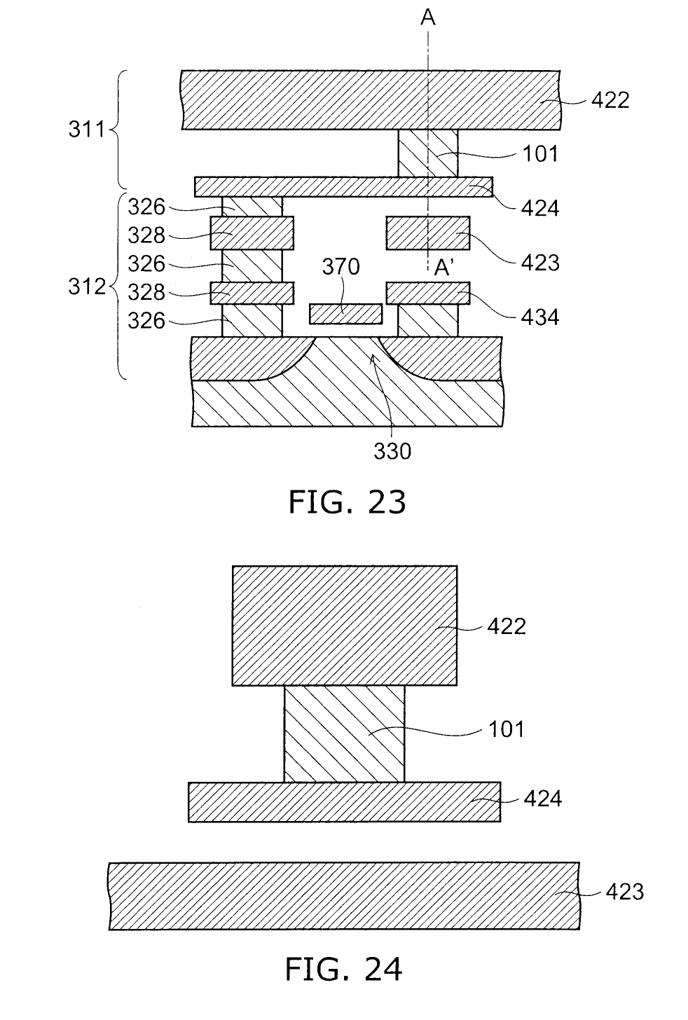

FIG. 23 is a schematic cross-sectional view illustrating a relevant part of the magnetic recording and reproducing apparatus according to the sixth embodiment.

FIG. 24 is a cross-sectional view taken along line A-A′ of FIG. 23.

That is, these drawings illustrate the configuration of a memory cell for one bit included in the magnetic recording and reproducing apparatus 301a. This memory cell includes a memory element portion 311 and a transistor portion for address selection 312.

As illustrated in FIG. 23 and FIG. 24, the memory element portion 311 includes the magneto-resistance effect element 101 and a pair of interconnections 422 and 424 connected thereto. The magneto-resistance effect element 101 is manufactured by the method for manufacturing a magneto-resistance effect element according to the embodiment described above.

On the other hand, a switching transistor 330 connected through a via 326 and an embedded interconnection 328 is provided in the transistor portion for address selection 312. The switching transistor 330 performs the switching operation in accordance with a voltage applied to a gate 370 to control the opening and closing of the current pathway between the magneto-resistance effect element 101 and an interconnection 434.

An interconnection 423 for writing is provided below the magneto-resistance effect element 101 in a direction nearly orthogonal to the interconnection 422. The interconnections 422 and 423 may be formed of, for example, aluminum (Al), copper (Cu), tungsten (W), or tantalum (Ta) or an alloy containing one of them.

The interconnection 422 mentioned above corresponds to the bit line 322, and the interconnection 423 corresponds to the word line 323.

In the memory cell with such a configuration, when writing bit information on the magneto-resistance effect element 101, a write pulse current is passed through the interconnections 422 and 423, and a synthetic magnetic field induced by the currents is applied to the recording layer of the magneto-resistance effect element to appropriately invert the magnetization of the recording layer.

When reading out bit information, a sense current is passed through the interconnection 422, the magneto-resistance effect element 101 including the magnetic recording layer, and the interconnection 424, and the resistance value or the change of the resistance value of the magneto-resistance effect element 101 is measured.

The magnetic recording and reproducing apparatuses 301 and 301a according to the embodiment use the magneto-resistance effect element according to the embodiment described above, and thereby can surely control magnetic domains of the recording layer to ensure reliable writing and perform also reliable readout, even for a minute cell size.

Here, the PIT and the IAO processing described above are preferably performed as a formation process for obtaining the CCP structure interposed in the free layer. In this case, since the material of the current path contains much magnetic element (contains 50% or more one element of Fe, Co, and Ni), the bottom metallic layer 15 and the top metallic layer 17 are not needed in particular, and the material of the intermediate layer 16 can be used as is.

Furthermore, the magnetic recording and reproducing apparatus according to the embodiment can be used for a longitudinal magnetic recording type and a perpendicular magnetic recording type. Moreover, the magnetic recording and reproducing apparatus may be what is called a fixed type which includes a specific magnetic recording medium steadily, or what is called a removal type in which the magnetic recording medium is exchangeable.

In the specification of the application, “perpendicular” and “parallel” refer to not only strictly perpendicular and strictly parallel but also include, for example, the variation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may appropriately select specific configurations of components of magnet-resistance effect elements such as first magnetic layers, second magnetic layers, intermediate layers, insulating layers, conductive portions, structure bodies, first nonmagnetic layers, and second nonmagnetic layers from known art and similarly practice the invention. Such practice is included in the scope of the invention to the extent that similar effects thereto are obtained.

Further, any two or more components of the specific examples may be combined within the extent of technical feasibility; and such combinations are included in the scope of the invention to the extent that the purport of the invention is included.

Moreover, all methods for manufacturing a magneto-resistance effect element, magneto-resistance effect elements, magnetic head assemblies, and magnetic recording and reproducing apparatuses by an appropriate design modification by one skilled in the art based on the methods for manufacturing a magneto-resistance effect element, the magneto-resistance effect elements, the magnetic head assemblies, and the magnetic recording and reproducing apparatuses described above as embodiments of the invention also are within the scope of the invention to the extent that the purport of the invention is included.

Furthermore, various alterations and modifications within the spirit of the invention will be readily apparent to those skilled in the art. All such alterations and modifications should be seen as within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

1. A method for manufacturing a magneto-resistance effect element having a first magnetic layer including a ferromagnetic material, a second magnetic layer including a ferromagnetic material, and an intermediate layer provided between the first magnetic layer and the second magnetic layer, the intermediate layer having an insulating layer and a conductive portion penetrating through the insulating layer, the method comprising:
forming a structure body having the insulating layer and the conductive portion penetrating through the insulating layer;
performing a first treatment including irradiating the structure body with at least one of an ion including at least one selected from the group consisting of argon, xenon, helium, neon and krypton and a plasma including at least one selected from the group consisting of argon, xenon, helium, neon and krypton; and
performing a second treatment including at least one of exposure to a gas containing oxygen, irradiation of ion beam containing oxygen, irradiation of plasma containing oxygen, exposure to a gas containing nitrogen, irradiation of ion beam containing nitrogen, and irradiation of plasma containing nitrogen, to the structure body submitted to the first treatment.

2. The method according to claim 1, wherein
the irradiation of ion beam containing oxygen includes irradiation of ion beam containing oxygen and at least one selected from the group consisting of argon, xenon, helium, neon and krypton,
the irradiation of plasma containing oxygen includes irradiation of plasma containing oxygen and at least one selected from the group consisting of argon, xenon, helium, neon and krypton,
the irradiation of ion beam containing nitrogen includes irradiation of ion beam containing nitrogen and at least one selected from the group consisting of argon, xenon, helium, neon and krypton, and
the irradiation of plasma containing nitrogen includes irradiation of plasma containing nitrogen and at least one selected from the group consisting of argon, xenon, helium, neon and krypton.

3. The method according to claim 1, further comprising forming a non-magnetic layer on the structure body after the performing the second treatment.

4. The method according to claim 1, further comprising forming a non-magnetic layer on the structure body before the performing the first treatment.

5. The method according to claim 1, wherein the forming the structure body includes:
forming films to form a first metal film being to be the conductive portion and a second metal film being to be converted to the insulating film; and
converting the second metal film to the insulating film to form the structure body.

6. The method according to claim 5, wherein the converting includes at least one of:
irradiating the second metal film with at least one of an ion including at least one element selected from the group consisting of argon, xenon, helium, neon, and krypton and a plasma including at least one element selected from the group consisting of argon, xenon, helium, neon, and krypton; and
irradiating the second metal film with at least one of a ion including at least one of oxygen and nitrogen and a plasma including at least one of oxygen and nitrogen.

7. The method according to claim 5, wherein oxidation generation energy of the first metallic film is higher than oxidation generation energy of the second metallic film.

8. The method according to claim 5, wherein the first metallic film contains at least one selected from the group consisting of Cu, Au, and Ag and the second metallic film contains at least one selected from the group consisting of Al, Si, Hf, Ti, Ta, Mo, W, Nb, Mg, Cr, and Zr.

9. The method according to claim 1, wherein
the forming the structure body includes oxidation treatment and
the second treatment includes a treatment with an oxidation power smaller than an oxidation power of the oxidation treatment included in the forming the structure body.

10. The method according to claim 1, wherein
the forming the structure body includes oxidation treatment using an ion beam and
the second treatment includes a treatment using an ion beam with an accelerating voltage smaller than an accelerating voltage of the ion beam in the oxidation treatment included in the forming the structure body.

11. The method according to claim 1, further comprising:
forming a first nonmagnetic layer provided between the first magnetic layer and the composite layer; and
forming a second nonmagnetic layer provided between the second magnetic layer and the composite layer,
the forming the structure body being performed after the forming the first nonmagnetic layer, and
the forming the second nonmagnetic layer being performed after the second treatment.

12. The method according to claim 1, further comprising:
forming a first nonmagnetic layer provided between the first magnetic layer and the composite layer; and
forming a second nonmagnetic layer provided between the second magnetic layer and the composite layer,
the forming the structure body being performed after the forming the first nonmagnetic layer, and
the forming the second nonmagnetic layer being performed between the forming the structure body and the first treatment.

13. The method according to claim 1, wherein
the second treatment includes oxygen gas treatment using an Ar ion beam,
the first treatment includes a treatment using a high-frequency power which is set from 20 watts with plus 20% to 20 watts with minus 20%.

14. The method according to claim 1, wherein
the second treatment includes oxygen gas treatment using a Xe ion beam and
the first treatment includes a treatment using a high-frequency power which is set from 40 watts with plus 20% to 40 watts with minus 20%.

15. A magnetic head assembly, comprising:
a magneto-resistance effect element;
a suspension mounting the magneto-resistance effect element in one edge of the suspension; and
an actuator arm connected to another edge of the suspension,
the magneto-resistance effect element including:
a first magnetic layer including the ferromagnetic material;
a second magnetic layer including the ferromagnetic material; and
an intermediate layer provided between the first magnetic layer and the second magnetic layer, the intermediate layer having the insulating layer and the conductive portion penetrating through the insulating layer,
the magneto-resistance effect element being manufactured by a method including:
forming a structure body having the insulating layer and the conductive portion penetrating through the insulating layer;
performing a first treatment including irradiating the structure body with at least one of an ion including at least one selected from the group consisting of argon, xenon, helium, neon and krypton and a plasma including at least one selected from the group consisting of argon, xenon, helium, neon and krypton; and
performing a second treatment including at least one of exposure to a gas containing oxygen, irradiation of ion beam containing oxygen, irradiation of plasma containing oxygen, exposure to a gas containing nitrogen, irradiation of ion beam containing nitrogen, and irradiation of plasma containing nitrogen, to the structure body submitted to the first treatment.

16. A magnetic recording and reproducing apparatus, comprising:
a magnetic head assembly including;
a magneto-resistance effect element;
a suspension mounting the magneto-resistance effect element in one edge of the suspension; and
an actuator arm connected to another edge of the suspension; and
a magnetic recording medium, information being recorded in the magnetic recording medium by using the magneto-resistance effect element mounted on the magnetic head assembly,
the magneto-resistance effect element, including:
a first magnetic layer including the ferromagnetic material;
a second magnetic layer including the ferromagnetic material; and
an intermediate layer provided between the first magnetic layer and the second magnetic layer, the intermediate layer having the insulating layer and the conductive portion penetrating through the insulating layer,
the magneto-resistance effect element being manufactured by a method including:
forming a structure body having the insulating layer and the conductive portion penetrating through the insulating layer;
performing a first treatment including irradiating the structure body with at least one of an ion including at least one selected from the group consisting of argon, xenon, helium, neon and krypton and a plasma including at least one selected from the group consisting of argon, xenon, helium, neon and krypton; and
performing a second treatment including at least one of exposure to a gas containing oxygen, irradiation of ion beam containing oxygen, irradiation of plasma containing oxygen, exposure to a gas containing nitrogen, irradiation of ion beam containing nitrogen, and irradiation of plasma containing nitrogen, to the structure body submitted to the first treatment.
